(19) United States
(12) Patent Application Publication
(10) Pub. No.: US 2024/0324027 A1
(43) Pub. Date: Sep. 26, 2024

(54) METHOD, USER EQUIPMENT, AND NETWORK NODE FOR FEATURE BASED RANDOM ACCESS

(71) Applicant: Telefonaktiebolaget LM Ericsson (publ), Stockholm (SE)

(72) Inventors: Jonas SEDIN, Brentford, Greater London (GB); Zhipeng LIN, Nanjing, Jiangsu (CN)

(73) Assignee: Telefonaktiebolaget LM Ericsson (publ), Stockholm (SE)

(21) Appl. No.: 18/570,560

(22) PCT Filed: May 16, 2022
(86) PCT No.: PCT/CN2022/092934

§ 371 Date: Dec. 14, 2023

(30) Foreign Application Priority Data
Jun. 18, 2021 (WO) PCT/CN2021/100922
Jun. 25, 2021 (WO) PCT/CN2021/102258
Jul. 23, 2021 (WO) PCT/CN2021/108220

(51) Int. Cl. H04W 74/0836; H04W 8/22; H04W 74/00; H04W 74/04

(52) U.S. Cl. CPC H04W 74/0836; H04W 8/22; H04W 74/006; H04W 74/04

(57) ABSTRACT

The present disclosure is related to a UE, a network node, and methods for feature based random access. A method at a UE for performing a random access (RA) procedure with a network node comprises: transmitting, to the network node, a first message comprising a physical random access channel (PRACH) preamble to initiate the RA procedure: receiving, from the network node, a second message in response to the first message: determining whether a feature is to be performed or not at least partially based on at least one of the second message, a configuration at the UE, and a capability of the UE; and transmitting, to the network node, a third message with or without the feature performed depending on a result of the determination.

### CROSS-REFERENCE TO RELATED APPLICATION(S)

This application claims priority to the PCT International Application No. PCT/CN2021/100922, entitled “METHOD, USER EQUIPMENT, AND NETWORK NODE FOR FEATURE BASED RANDOM ACCESS PROCEDURE”, filed on Jun. 18, 2021, the PCT International Application No. PCT/CN2021/102258, entitled “METHOD, USER EQUIPMENT, AND NETWORK NODE FOR FEATURE BASED PREAMBLE GROUPING”, filed on Jun. 25, 2021, and the PCT International Application No. PCT/CN2021/108220, entitled “METHOD, USER EQUIPMENT, AND NETWORK NODE FOR FEATURE BASED RANDOM ACCESS”, filed on Jul. 23, 2021, which are incorporated herein by reference in their entirety.

### TECHNICAL FIELD

The present disclosure is related to the field of telecommunication, and in particular, to a user equipment (UE), a network node, and methods for feature based random access.

### BACKGROUND

With the development of the electronic and telecommunications technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

In order to be able to carry the data across the 5G NR RAN, data and information is organized into a number of data channels. By organizing the data into various channels, a 5G communications system is able to manage the data transfers in an orderly fashion and the system is able to understand what data is arriving and hence it is able to process the data in the required fashion. As there are many different types of data that need to be transferred-user data obviously needs to be transferred, but so does control information to manage the radio communications link, as well as data to provide synchronization, access, and the like. All of these functions are essential and require the transfer of data over the RAN.

In order to group the data to be sent over the 5G NR RAN, the data is organized in a very logical way. As there are many different functions for the data being sent over the radio communications link, they need to be clearly marked and have defined positions and formats. To ensure this happens, there are several different forms of data “channel” that are used. The higher level ones are “mapped” or contained within others until finally at the physical level, the channel contains data from higher level channels.

In this way there is a logical and manageable flow of data from the higher levels of the protocol stack down to the physical layer.

There are three main types of data channels that are used for a 5G RAN, and accordingly the hierarchy is given below.
Logical channel: Logical channels can be one of two groups: control channels and traffic channels:
   Control channels: The control channels are used for the transfer of data from the control plane; and
   Traffic channels: The traffic logical channels are used for the transfer of user plane data.
Transport channel: Is the multiplexing of the logical data to be transported by the physical layer and its channels over the radio interface.
Physical channel: The physical channels are those which are closest to the actual transmission of the data over the radio access network/5G Radio Frequency (RF) signal. They are used to carry the data over the radio interface.

The physical channels often have higher level channels mapped onto them for providing a specific service. Additionally, the physical channels carry payload data or details of specific data transmission characteristics like modulation, reference signal multiplexing, transmit power, RF resources, etc.

The 5G physical channels are used to transport information over the actual radio interface. They have the transport channels mapped into them, but they also include various physical layer data required for the maintenance and optimization of the radio communications link between a UE and a base station (BS).

There are three physical channels for each of the uplink and downlink: Physical Downlink Shared Channel (PDSCH), Physical Downlink Control Channel (PDCCH), and Physical Broadcast Channel (PBCH) for downlink, and Physical Random Access Channel (PRACH), Physical Uplink Shared Channel (PUSCH), and Physical Uplink Control Channel (PUCCH) for uplink.

### SUMMARY

According to a first aspect of the present disclosure, a method at a UE for performing an RA procedure with a network node is provided. The method comprises: transmitting, to the network node, a first message comprising a PRACH preamble to initiate the RA procedure; receiving, from the network node, a second message in response to the first message; determining whether a feature is to be performed or not at least partially based on at least one of the second message, a configuration at the UE, and a capability of the UE; and transmitting, to the network node, a third message with or without the feature performed depending on a result of the determination.

In some embodiments, the feature comprises at least one of: Msg3 repetition; repetition for uplink transmission scheduled by the second message; a network slice; small data transmission (SDT); a UE with reduced capability (RedCap UE); a random access in non-terrestrial network; and a specific service type or UE priority. In some embodiments, the second message comprises a random access response (RAR) and/or a downlink control information (DCI), wherein the step of determining whether a feature is to be performed or not comprises: determining whether the feature is to be performed or not at least partially based on at least one of the configuration at the UE, the capability of the UE, the RAR, and the DCI. In some embodiments, the RA procedure is a contention free random access (CFRA) procedure.

In some embodiments, before the step of determining whether a feature is to be performed or not, the method further comprises: receiving the configuration indicating whether the second message shall be decoded as for scheduling the transmission of the third message with or without the feature performed. In some embodiments, the configuration is a flag in a CFRA configuration indicating whether the second message shall be decoded as for scheduling the transmission of the third message with or without the feature performed.

In some embodiments, when the RA procedure is initiated for beam failure recovery (BFR), the configuration indicates that the second message shall always be decoded as for scheduling the transmission of the third message with the feature performed. In some embodiments, when the RA procedure is initiated for a handover, the configuration indicates that the second message shall always be decoded as for scheduling the transmission of the third message with the feature performed. In some embodiments, the flag is carried by a handover command received from another network node. In some embodiments, the configuration is a preamble index, which is signaled to the UE for its PRACH transmission, indicating whether the second message shall be decoded as for scheduling the transmission of the third message with or without the feature performed.

In some embodiments, the configuration is received via at least one of: dedicated radio resource control (RRC) signaling; medium access control (MAC) control element (CE); and broadcasted system information. In some embodiments, the configuration is received from the network node, wherein the configuration indicates that the second message shall always be decoded as for scheduling the transmission of the third message with the feature performed in response to determining that the capability of the UE supports the feature. In some embodiments, the configuration is a flag in a DCI that orders the UE to initiate the RA procedure. In some embodiments, the flag indicates whether a legacy time domain resource allocation (TDRA) table or another TDRA table for enabling the feature shall be used for scheduling uplink resource for transmission of the third message. In some embodiments, before the step of receiving, from the network node, a second message, the method further comprises: transmitting, to the network node, a capability indicator indicating the capability of the UE, wherein the step of determining whether a feature is to be performed or not comprises: determining whether the second message shall be decoded as for scheduling the transmission of the third message with or without the feature performed based on the capability of the UE.

In some embodiments, before the step of transmitting, to the network node, a first message, the method further comprises: receiving an indicator indicating at least two sets of PRACH resources that comprise a first set indicating that the feature is requested by the UE and a second set indicating that the feature is not requested by the UE, wherein the step of transmitting, to the network node, a first message comprises: transmitting the first message by using a PRACH resource that is selected from the first set or the second set depending on whether the feature is to be requested or not by the UE, wherein the step of determining whether a feature is to be performed or not comprises: determining whether the second message shall be decoded as for scheduling the transmission of the third message with or without the feature performed based on from which of the first set and the second set the PRACH resource is selected.

In some embodiments, whether the feature is to be requested or not by the UE is determined by: measuring reference signal received power (RSRP) of downlink pathloss reference; comparing the measured RSRP with a configured threshold; determining that the feature is to be requested in response to determining that the measure RSRP is lower than the configured threshold; and determining that the feature is not to be requested in response to determining that the measure RSRP is higher than or equal to the configured threshold.

In some embodiments, the step of determining whether a feature is to be performed or not comprises: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step of determining whether a feature is to be performed or not comprises: determining that the second message shall be decoded as for scheduling the transmission of the third message without the feature performed.

In some embodiments, after the step of transmitting, to the network node, a first message and before the step of determining whether a feature is to be performed or not, the method further comprises: receiving, from the network node, another second message in response to the first message, wherein the step of determining whether a feature is to be performed or not comprises: determining whether first uplink resource can be decoded from the second message for transmission of the third message with the feature performed in response to determining that the capability of the UE supports the feature; determining the first uplink resource in response to determining that the first uplink resource can be decoded from the second message; and determining second uplink resource that is decoded from the other second message for transmission of the third message without the feature performed in response to determining that no uplink resource can be decoded from the second message.

In some embodiments, the RA procedure is a fallback from a CFRA procedure with 2-step RA type to an RA procedure with 4-step RA type. In some embodiments, before the step of determining whether a feature is to be performed or not, the method further comprises: receiving the configuration indicating whether the second message shall be decoded as for scheduling the transmission of the third message with or without the feature performed. In some embodiments, the configuration is received from another network node, wherein the configuration is a flag in a CFRA configuration indicating whether the second message shall be decoded as for scheduling the transmission of the third message with or without the feature performed. In some embodiments, the configuration is a flag in a DCI that orders the UE to initiate the RA procedure. In some embodiments, the configuration is received via at least one of: dedicated RRC signaling; MAC CE; and broadcasted system information.

In some embodiments, before the step of transmitting, to the network node, a first message, the method further comprises: receiving an indicator indicating at least two sets of PRACH resources that comprise a first set indicating that the feature is requested by the UE and a second set indicating that the feature is not requested by the UE, wherein the step of transmitting, to the network node, a first message comprises: transmitting the first message by using a PRACH resource that is selected from the first set or the second set depending on whether the feature is to be requested or not by the UE, wherein the step of determining whether a feature is to be performed or not comprises: determining whether the second message shall be decoded as for scheduling the transmission of the third message with or without the feature performed based on from which of the first set and the second set the PRACH resource is selected.

In some embodiments, before the step of receiving, from the network node, a second message, the method further comprises: transmitting, to the network node, a capability indicator indicating the capability of the UE, wherein the step of determining whether a feature is to be performed or not comprises: determining whether the second message shall be decoded as for scheduling the transmission of the third message with or without the feature performed based on the capability of the UE.

In some embodiments, the step of determining whether a feature is to be performed or not comprises: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step of determining whether a feature is to be performed or not comprises: determining that the second message shall be decoded as for scheduling the transmission of the third message without the feature performed. In some embodiments, after the step of transmitting, to the network node, a first message and before the step of determining whether a feature is to be performed or not, the method further comprises: receiving, from the network node, another second message in response to the first message, wherein the step of determining whether a feature is to be performed or not comprises: determining whether first uplink resource can be decoded from the second message for transmission of the third message with the feature performed in response to determining that the capability of the UE supports the feature; determining first uplink resource that is decoded from the second message for transmission of the third message with the feature performed in response to determining that the first uplink resource can be decoded from the second message; and determining second uplink resource that is decoded from the other second message for transmission of the third message without the feature performed in response to determining that no uplink resource can be decoded from the second message.

In some embodiments, the RA procedure is a fallback from a CBRA procedure with 2-step RA type to an RA procedure with 4-step RA type. In some embodiments, before the step of determining whether a feature is to be performed or not, the method further comprises: receiving the configuration indicating whether the second message shall be decoded as for scheduling the transmission of the third message with or without the feature performed. In some embodiments, the configuration is received via at least one of: dedicated RRC signaling; MAC CE; and broadcasted system information.

In some embodiments, before the step of transmitting, to the network node, a first message, the method further comprises: receiving an indicator indicating at least two sets of PRACH resources that comprise a first set indicating that the feature is requested by the UE and a second set indicating that the feature is not requested by the UE, wherein the step of transmitting, to the network node, a first message comprises: transmitting the first message by using a PRACH resource that is selected from the first set or the second set depending on whether the feature is to be requested or not by the UE, wherein the step of determining whether a feature is to be performed or not comprises: determining whether the second message shall be decoded as for scheduling the transmission of the third message with or without the feature performed based on from which of the first set and the second set the PRACH resource is selected.

In some embodiments, the step of determining whether a feature is to be performed or not comprises: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step of determining whether a feature is to be performed or not comprises: determining that the second message shall be decoded as for scheduling the transmission of the third message without the feature performed. In some embodiments, after the step of transmitting, to the network node, a first message and before the step of determining whether a feature is to be performed or not, the method further comprises: receiving, from the network node, another second message in response to the first message, wherein the step of determining whether a feature is to be performed or not comprises: determining whether first uplink resource can be decoded from the second message for transmission of the third message with the feature performed in response to determining that the capability of the UE supports the feature; determining first uplink resource that is decoded from the second message for transmission of the third message with the feature performed in response to determining that the first uplink resource can be decoded from the second message; and determining second uplink resource that is decoded from the other second message for transmission of the third message without the feature performed in response to determining that no uplink resource can be decoded from the second message.

In some embodiments, a PRACH resource comprises at least one of: a PRACH time/frequency resource; and a PRACH preamble sequence.

According to a second aspect of the present disclosure, a UE is provided. The UE comprises: a processor; a memory storing instructions which, when executed by the processor, cause the processor to perform the method of any of the first aspect.

According to a third aspect of the present disclosure, a method at a network node for performing an RA procedure with a UE is provided. The method comprises: receiving, from the UE, a first message comprising a PRACH preamble to initiate the RA procedure; determining whether a feature shall be performed for the UE or not at least partially based on at least one of the first message, a configuration at the network node, and a capability of the UE; determining uplink resource for transmission of a third message by the UE at least partially based on the determination of whether the feature shall be performed for the UE or not; and transmitting, to the UE, a second message indicating the determined uplink resource.

In some embodiments, the method further comprises: receiving, from the UE, the third message with or without the feature performed depending on the determination of whether the feature shall be performed for the UE or not. In some embodiments, the feature comprises at least one of: Msg3 repetition; repetition for uplink transmission scheduled by the second message; a network slice; SDT; a RedCap UE; a random access in non-terrestrial network; and a specific service type or UE priority. In some embodiments, the second message comprises a RAR and/or a DCI.

In some embodiments, the RA procedure is a CFRA procedure. In some embodiments, before the step of transmitting, to the UE, a second message, the method further comprises: transmitting or broadcasting the configuration indicating whether the second message shall be decoded as for scheduling the transmission of the third message with or without the feature performed. In some embodiments, the configuration is a flag in a CFRA configuration indicating whether the second message shall be decoded as for scheduling the transmission of the third message with or without the feature performed. In some embodiments, when the RA procedure is initiated for BFR, the configuration indicates that the second message shall always be decoded as for scheduling the transmission of the third message with the feature performed. In some embodiments, when the RA procedure is initiated for a handover, the configuration indicates that the second message shall always be decoded as for scheduling the transmission of the third message with the feature performed.

In some embodiments, the configuration is a preamble index, which is signaled to the UE for its PRACH transmission, indicating whether the second message shall be decoded as for scheduling the transmission of the third message with or without the feature performed. In some embodiments, the configuration is transmitted via at least one of: dedicated RRC signaling; MAC CE; and broadcasted system information.

In some embodiments, the configuration indicates that the second message shall always be decoded as for scheduling the transmission of the third message with the feature performed in response to determining that the capability of the UE supports the feature. In some embodiments, the configuration is a flag in a DCI that orders the UE to initiate the RA procedure. In some embodiments, the flag indicates whether a legacy TDRA table or another TDRA table for enabling the feature shall be used for scheduling the uplink resource for transmission of the third message. In some embodiments, before the step of determining whether a feature shall be performed for the UE or not, the method further comprises: receiving, from the UE, a capability indicator indicating the capability of the UE, wherein the step of determining whether a feature shall be performed for the UE or not comprises: determining whether the second message shall be decoded as for scheduling the transmission of the third message with or without the feature performed based on the capability of the UE.

In some embodiments, before the step of receiving, from the UE, a first message, the method further comprises: transmitting an indicator indicating at least two sets of PRACH resources that comprise a first set indicating that the feature is requested by the UE and a second set indicating that the feature is not requested by the UE, wherein the step of receiving, from the UE, a first message comprises: receiving the first message by using a PRACH resource that is selected from the first set or the second set, wherein the step of determining whether a feature shall be performed for the UE or not comprises: determining whether the second message shall be decoded as for scheduling the transmission of the third message with or without the feature performed based on from which of the first set and the second set the PRACH resource is selected.

In some embodiments, the method further comprises one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed.

In some embodiments, the method further comprises: transmitting, to the UE, another second message indicating the second uplink resource. In some embodiments, the RA procedure is a fallback from a CFRA procedure with 2-step RA type to an RA procedure with 4-step RA type. In some embodiments, before the step of transmitting, to the UE, a second message, the method further comprises: transmitting or broadcasting the configuration indicating whether the second message shall be decoded as for scheduling the transmission of the third message with or without the feature performed. In some embodiments, the configuration is a flag in a CFRA configuration indicating whether the second message shall be decoded as for scheduling the transmission of the third message with or without the feature performed.

In some embodiments, the configuration is a flag in a DCI that orders the UE to initiate the RA procedure. In some embodiments, the configuration is transmitted via at least one of: dedicated RRC signaling; MAC CE; and broadcasted system information. In some embodiments, before the step of receiving, from the UE, a first message, the method further comprises: transmitting an indicator indicating at least two sets of PRACH resources that comprise a first set indicating that the feature is requested by the UE and a second set indicating that the feature is not requested by the UE, wherein the step of receiving, from the UE, a first message comprises: receiving the first message by using a PRACH resource that is selected from the first set or the second set, wherein the step of determining whether a feature shall be performed for the UE or not comprises: determining whether the second message shall be decoded as for scheduling the transmission of the third message with or without the feature performed based on from which of the first set and the second set the PRACH resource is selected.

In some embodiments, before the step of determining whether a feature is to be performed for the UE or not, the method further comprises: receiving, from the UE, a capability indicator indicating the capability of the UE, wherein the step of determining whether a feature is to be performed for the UE or not comprises: determining whether the second message shall be decoded as for scheduling the transmission of the third message with or without the feature performed based on the capability of the UE.

In some embodiments, the method further comprises one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed. In some embodiments, the method further comprises: transmitting, to the UE, another second message indicating the second uplink resource.

In some embodiments, the RA procedure is a fallback from a CBRA procedure with 2-step RA type to an RA procedure with 4-step RA type. In some embodiments, before the step of transmitting, to the UE, a second message, the method further comprises: transmitting or broadcasting the configuration indicating whether the second message shall be decoded as for scheduling the transmission of the third message with or without the feature performed. In some embodiments, the configuration is transmitted via at least one of: dedicated RRC signaling; MAC CE; and broadcasted system information.

In some embodiments, before the step of receiving, from the UE, a first message, the method further comprises: transmitting an indicator indicating at least two sets of PRACH resources that comprise a first set indicating that the feature is requested by the UE and a second set indicating that the feature is not requested by the UE, wherein the step of receiving, from the UE, a first message comprises: receiving the first message by using a PRACH resource that is selected from the first set or the second set, wherein the step of determining whether a feature shall be performed for the UE or not comprises: determining whether the second message shall be decoded as for scheduling the transmission of the third message with or without the feature performed based on from which of the first set and the second set the PRACH resource is selected.

In some embodiments, the method further comprises one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed.

In some embodiments, the method further comprises: transmitting, to the UE, another second message indicating the second uplink resource. In some embodiments, a PRACH resource comprises at least one of: a PRACH time/frequency resource; and a PRACH preamble sequence.

According to a fourth aspect of the present disclosure, a network node is provided. The network node comprises: a processor; a memory storing instructions which, when executed by the processor, cause the processor to perform the method of any of the third aspect.

According to a fifth aspect of the present disclosure, a computer program comprising instructions is provided. The instructions, when executed by at least one processor, cause the at least one processor to carry out the method of any of the first or third aspect.

According to a sixth aspect of the present disclosure, a carrier containing the computer program of the fifth aspect is provided. The carrier is one of an electronic signal, optical signal, radio signal, or computer readable storage medium.

According to a seventh aspect of the present disclosure, a telecommunications system is provided. The telecommunications system comprises one or more UEs of the second aspect; and at least one network node of the fourth aspect.

### BRIEF DESCRIPTION OF THE DRAWINGS

FIG. 1 shows flow charts illustrating exemplary Type-1 and Type-2 RA procedures, respectively, with which a UE and gNB according to an embodiment of the present disclosure may be operable.

FIG. 2 is a diagram illustrating an exemplary RAR that can be used in an RA procedure according to an embodiment of the present disclosure.

FIG. 3 is a diagram illustrating an exemplary one-to-one mapping between SSBs and PRACH occasions with which a UE and gNB according to an embodiment of the present disclosure may be operable.

FIG. 4 is a diagram illustrating an exemplary many-to-one mapping between SSBs and PRACH occasions with which a UE and gNB according to an embodiment of the present disclosure may be operable.

FIG. 5 is a diagram illustrating an exemplary preamble grouping in the related art.

FIG. 6 are flow charts illustrating problems with conventional RA procedures.

FIG. 7 is a flow chart illustrating an exemplary procedure for feature based random access according to an embodiment of the present disclosure.

FIG. 8 is a flow chart illustrating an exemplary method at a UE for feature based random access according to an embodiment of the present disclosure.

FIG. 9 is a flow chart illustrating an exemplary method at a network node for feature based random access according to an embodiment of the present disclosure.

FIG. 10 schematically shows an embodiment of an arrangement which may be used in a UE or a network node according to an embodiment of the present disclosure.

FIG. 11 is a block diagram of an exemplary UE according to an embodiment of the present disclosure.

FIG. 12 is a block diagram of an exemplary network node according to an embodiment of the present disclosure.

FIG. 13 schematically illustrates a telecommunication network connected via an intermediate network to a host computer according to an embodiment of the present disclosure.

FIG. 14 is a generalized block diagram of a host computer communicating via a base station with a user equipment over a partially wireless connection according to an embodiment of the present disclosure.

FIG. 15 to FIG. 18 are flowcharts illustrating methods implemented in a communication system including a host computer, a base station, and a user equipment according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as a random access procedure is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4th Generation Long Term Evolution (LTE), LTE-Advance (LTE-A), or 5G NR, etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “gNB” used herein may refer to a network node, a base station, a base transceiver station, an access point, a hot spot, a NodeB, an Evolved NodeB, a network element, or any other equivalents. Further, please note that the term “indicator” used herein may refer to a parameter, a coefficient, an attribute, a property, a setting, a configuration, a profile, an identifier, a field, one or more bits/octets, an information element, or any data by which information of interest may be indicated directly or indirectly.

Further, following 3GPP documents are incorporated herein by reference in their entireties:
3GPP TS 38.212 V16.6.0 (2021-06), 3rd Generation Partnership Project; Technical Specification Group Radio Access Network; NR; Multiplexing and channel coding (Release 16);
3GPP TS 38.213 V16.6.0 (2021-06), 3rd Generation Partnership Project; Technical Specification Group Radio Access Network; NR; Physical layer procedures for control (Release 16);
3GPP TS 38.321 V16.4.0 (2021-03), 3rd Generation Partnership Project; Technical Specification Group Radio Access Network; NR; Medium Access Control (MAC) protocol specification (Release 16); and
3GPP TS 38.331 V16.4.1 (2021-03), 3rd Generation Partnership Project; Technical Specification Group Radio Access Network; NR; Radio Resource Control (RRC) protocol specification (Release 16).

When a UE wants to access to a 5G NR network, it has to synchronize in downlink as well as in uplink. Downlink synchronization may be obtained after successfully decoding Synchronous Signal and PBCH block (SSB). In order to establish uplink synchronization and an RRC connection, the UE has to perform a random access procedure.

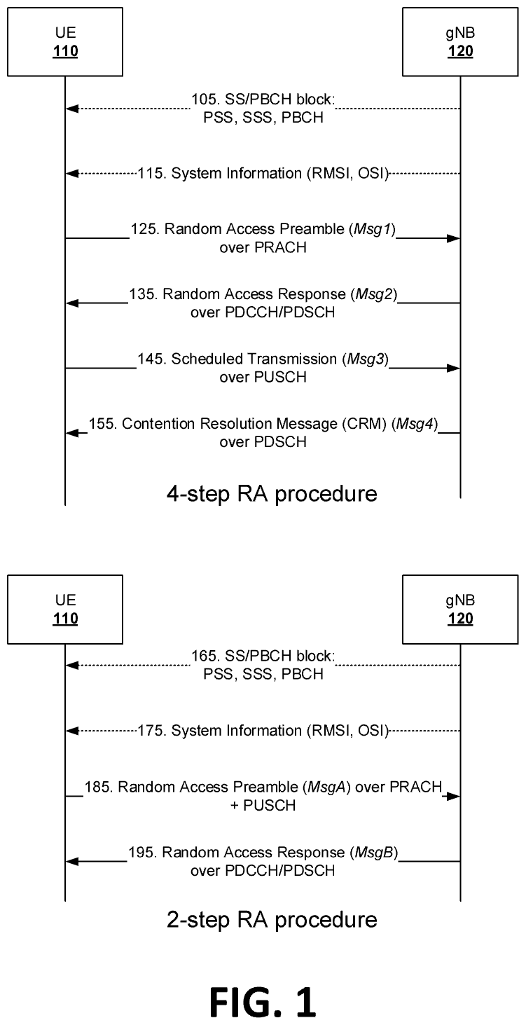

FIG. 1 shows flow charts illustrating exemplary Type-1 and Type-2 RA procedures, respectively, with which a UE and gNB according to an embodiment of the present disclosure may be operable. As shown in FIG. 1, there are two types of RA procedures:
Type-1 RA procedure, also known as 4-step RACH, or 4-step RA procedure; and
Type-2 RA procedure, also known as 2-step RACH, or 2-step RA procedure.

The two types of RA procedures may be triggered upon request of a PRACH transmission by higher layers of the UE or by a PDCCH order from the gNB.

Further, RA procedures may also be classified into Contention Based Random Access (CBRA) or Non Contention or Contention Free Random Access (CFRA) depending on how its resource is selected. In the contention based RA procedure, a UE may select a preamble randomly from a pool of preambles shared with other UEs. This means that the UE has a potential risk of selecting a same preamble as another UE and subsequently may experience conflict or contention. The gNB may use a contention resolution mechanism to handle this type of access requests. In this procedure, the result is random and not all RA succeeds.

Referring to the top flow chart of FIG. 1, an exemplary 4-step RA procedure may comprise four steps 125 to 155 for a UE 110 to access a gNB 120 after necessary system information, which is broadcasted by the gNB 120, is obtained at the steps 105 and 115.

At step 105, the UE 110 may receive a Master Information Block (MIB) from the gNB 120 by detecting an SSB which may comprise a Primary Synchronous Signal (PSS), a Secondary Synchronous Signal (SSS), and a PBCH carrying the MIB. Upon successful reception and decoding of the MIB, the UE 110 may determine time/frequency positions for monitoring Remaining Minimum System Information (RMSI) or System Information Block 1 (SIB1) broadcasted by the gNB 120, for example, by a pdcch-ConfigSIB1 information element (IE) comprised in the MIB.

At step 115, the UE 110 may receive the RMSI and Other System Information (OSI) from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 4-step RA procedure. For example, the UE 110 may determine a set of preambles by a RACH-ConfigCommon IE which can be used later during the 4-step RA procedure.

At step 125, the UE 110 may transmit a preamble which is selected from the set of preambles determined at the step 115 to the gNB 120 in Msg1.

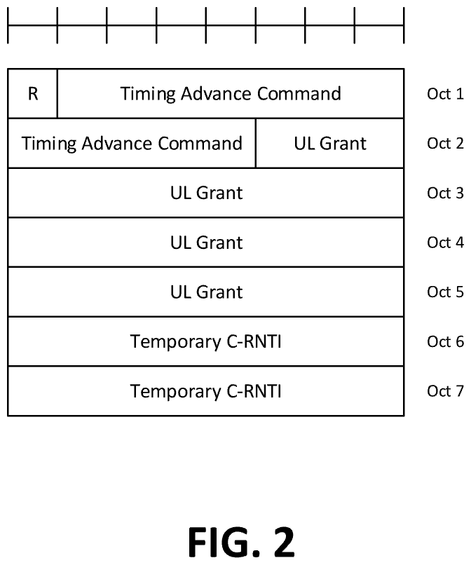

At step 135, upon reception of Msg1, the gNB 120 may select a Temporary Cell-Radio Network Temporary Identifier (TC-RNTI) and uplink and downlink scheduling resources for the UE 110. Then, the gNB 120 may transmit an RA response (RAR or Msg2) over PDCCH/PDSCH. The response may contain the RA-preamble identifier, timing alignment information, initial uplink grant, and the TC-RNTI. One PDSCH may carry RA responses to multiple UEs. The Msg2 is said to consist of a PDCCH that assigns the PDSCH reception, where the PDSCH reception may contain a RAR MAC Protocol Data Unit (PDU). The RAR MAC PDU may further contain several fields, such as the Timing Advance Command used to align the timing of the UE, and the Temporary RNTI and the UL grant which are used to scramble and schedule the Msg3. An exemplary MAC RAR payload is shown in FIG. 2.

For example, the RAR UL grant may be defined with following fields:

TABLE 1
Random Access Response Grant Content field size

| RAR grant field | Number of bits |
|---|---|
| Frequency hopping flag | 1 |
| PUSCH frequency | 14, for operation without shared |
| resource allocation | spectrum channel access |
| | 12, for operation with shared |
| | spectrum channel access |
| PUSCH time resource | 4 |
| allocation | |
| MCS | 4 |
| TPC command for PUSCH | 3 |
| CSI request | 1 |
| ChannelAccess-CPext | 0, for operation without shared |
| | spectrum channel access |
| | 2, for operation with shared |
| | spectrum channel access |

On the other hand, after transmitting the preamble, the UE 110 may monitor the PDCCH and wait for the RAR within an RA response window:
If the UE 110 receives a response containing an RA-preamble identifier which is the same as the identifier contained in the transmitted RA preamble, the response is successful. The UE 110 may then transmit uplink scheduling information later.
If the UE 110 does not receive a response within the RA response window or fails to verify the response, the response fails. In this case, if the number of RA attempts is less than the upper limit (e.g., 10), the UE 110 may retry the RA procedure. Otherwise, the RA procedure fails.

Further, the UE 110 may use the timing alignment information comprised in the RAR to adjust the timing of any subsequent PUSCH transmission, allowing PUSCH to be received at the gNB 120 with a timing accuracy within the cyclic prefix (CP). Without this timing advance functionality, a very large CP would be needed in order to be able to demodulate and detect PUSCH, unless the system is applied in a cell with very short distance between the UE 110 and the gNB 120. Since NR will also support larger cells, there is a need for providing a timing advance to the UE 110.

At step 145, the UE 110 may transmit uplink scheduling information (Msg3) over the PUSCH. The signaling messages and information transmitted by the UE 110 may vary across different RA scenarios and some examples are listed below:
Initial RRC connection setup: The RRCSetupRequest message (carrying NAS UE_ID) is transmitted over the common control channel (CCCH) in Transparent Mode™ at the Radio Link Control (RLC) layer. The message is not segmented.
RRC connection reestablishment: The RRC Reestablishment Request message (not carrying the NAS message) is transmitted over the CCCH in TM at the RLC layer. The message is not segmented.
Handover: Contention-based RA, instead of contention-free RA, is triggered if the UE 110 accesses the target cell and no dedicated preambles are available during a handover. The RRC Handover Confirm message and C-RNTI are transmitted over the dedicated control channel (DCCH). If required, a buffer status report (BSR) may also be carried.
Other scenarios: At least the C-RNTI of the UE 110 may be transmitted.

At step 155, after transmitting the Msg3, a contention resolution timer may be started at the UE 110. The gNB 120 may assist the UE 110 in contention resolution using the C-RNTI on the PDCCH or using the UE Contention Resolution Identity IE on the PDSCH.

The UE 110 may keep monitoring the PDCCH before the timer expires and considers the contention resolution successful and stops the timer if either of the following conditions is met:
The UE 110 receives a PDCCH on its C-RNTI.
The UE 110 successfully decodes the MAC PDU addressed by the temporary C-RNTI. Specifically, the UE Contention Resolution Identity IE received over the PDSCH is the same as that carried in Msg3 sent by the UE.

If the contention resolution timer expires, the UE 110 may consider the contention resolution failed. Then, the UE 110 may perform the RA procedure again if the number of RA attempts has not reached the upper limit. If the number of RA attempts has reached its upper limit, the RA procedure fails.

In non-contention based Random Access or CFRA, the preamble may be pre-allocated by the gNB 120 and such preambles may be known as dedicated random access preamble. The dedicated preamble may be provided to the UE 110 either via RRC signalling (e.g., allocated preamble(s) can be specified within an RRC message) or PHY Layer signalling (e.g., DCI on the PDCCH). Therefore, there is no preamble conflict. When dedicated resources are insufficient, the gNB 120 may instruct UEs to initiate contention-based RA.

The gNB 120 may allocate an RA preamble to the UE 110 and sent it using an RRC message or DCI signaling. Some scenarios are listed below:
Handover: The MobilityControlInfo IE sent by the source gNB may carry the allocated preamble;
DL Data Arrival: When downlink data arrives at the gNB 120, the gNB 120 may instruct the UE 110 to initiate an RA procedure through DCI over PDCCH, which carries the allocated preamble;
Non-Standalone (NSA) networking: When NR cells are added in NSA, the gNB 120 may instruct the UE 110 to initiate an RA procedure through the PDCCH, which carries the allocated preamble.

Referring to the bottom flow chart of FIG. 1, an exemplary 2-step RA procedure may comprise two steps 185 and 195 for a UE 110 to access a gNB 120 after necessary system information, which is broadcasted by the gNB 120, is obtained at the steps 165 and 175.

Similar to the step 105, at step 165, the UE 110 may receive a MIB from the gNB 120 by detecting an SSB. Upon successful reception and decoding of the MIB, the UE 110 may determine time/frequency positions for monitoring RMSI or SIB1 broadcasted by the gNB 120.

Similar to the step 115, at step 175, the UE 110 may receive the RMSI and OSI from the gNB 120. For example, the UE 110 may receive and decode the RMSI (SIB1) based on the information determined at the step 105 to determine time/frequency positions for monitoring OSI broadcasted by the gNB 120, for example, by a searchSpaceOtherSystemInformation IE comprised in the SIB1. Further, the UE 110 may also obtain any parameters necessary for the 2-step RA procedure. For example, the UE 110 may determine available time/frequency occasions for PRACH by a msgA-ConfigCommon IE comprised in the SIB1, which can be used later during the 2-step RA procedure.

Similar to the step 125, at the step 185, the UE 110 may transmit to the gNB 120 an RA preamble (MsgA), which may be pre-allocated by the gNB 120 when it is a CFRA procedure, together with higher layer data such as an RRC connection request possibly with some small additional payload on PUSCH. In such a case, no confliction with other UEs will happen.

Similar to the step 135, the gNB 120 may transmit an RA response (MsgB) to the UE 110. Since no conflict with other UEs will occur, and the steps for contention resolving (e.g., Msg3 and Msg4 in the 4-step RA procedure) may be omitted.

In the handover scenario, the RA response may contain the timing alignment information and initial uplink grant. In the DL data arrival scenario, when downlink data arrives at the gNB 120, the RA response may contain the timing alignment information and RA preamble identifier (RAPID). In the NSA networking scenario, when NR cells are added in NSA, the RA response may contain the timing alignment information and RAPID.

Further, in the 2-step RA procedure, if the network (e.g., the gNB 120) is able to decode the MsgA preamble but not the MsgA PUSCH, the gNB 120 may order the UE 110 to fallback to a 4-step RA procedure with a fallback RAR. The fallback RAR may schedule a Msg3 in the 4-step RA procedure. The fallback RAR MAC payload may have a similar structure as that shown in FIG. 2, and thereof its detailed description is omitted for simplicity.

Please note that although FIG. 1 shows a 4-step contention-based RA procedure (or CBRA of Type 1) and a 2-step non-contention-based RA procedure (or CFRA of Type 2), the present disclosure is not limited thereto. In other embodiments, other RA procedures may also be applicable, such as, a 4-step non-contention-based RA procedure (or CFRA of Type 1) and/or a 2-step contention-based RA procedure (or CBRA of Type 2).

In 3GPP RAN #90e, the following objectives have been approved for NR coverage enhancement work item in NR Rel-17 for PUSCH:
Specification of PUSCH enhancements [RAN1, RAN4]
   Specify the following mechanisms for enhancements on PUSCH repetition type A [RAN1]
      Increasing the maximum number of repetitions up to a number to be determined during the course of the work.
      The number of repetitions counted on the basis of available UL slots.
   Specify mechanism(s) to support transport block (TB) processing over multi-slot PUSCH [RAN1]
      TB size (TBS) determined based on multiple slots and transmitted over multiple slots.
   Specify mechanism(s) to enable joint channel estimation [RAN1, RAN4]
      Mechanism(s) to enable joint channel estimation over multiple PUSCH transmissions, based on the conditions to keep power consistency and phase continuity to be investigated and specified if necessary by RAN4 [RAN1, RAN4]
         Potential optimization of DMRS location/granularity in time domain is not precluded
      Inter-slot frequency hopping with inter-slot bundling to enable joint channel estimation [RAN1]
Specification of PUCCH enhancements [RAN1, RAN4]
   Specify signaling mechanism to support dynamic PUCCH repetition factor indication [RAN1]
   Specify mechanism to support DMRS bundling across PUCCH repetitions [RAN1, RAN4]
Specify mechanism(s) to support Type A PUSCH repetitions for Msg3 [RAN1]

In some embodiments of the present disclosure, repetition of PUSCH scheduled by RAR and/or DCI in CFRA which is in the scope of the objective for the Type A PUSCH repetitions for Msg3 will be described.

As already described with reference to FIG. 1, two types of random access procedures are supported in NR till release 16, where a MsgA PUSCH or a Msg3 PUSCH transmission is used for transmission of RRC setup request message in 2-step RACH RA type and 4-step RA type, respectively. Neither Msg3 PUSCH nor MsgA PUSCH can be repeated in NR up to Rel-16.

In both 4-step RACH and 2-step RACH, PRACH resources may be selected based on the SSB selection and a SSB to RACH occasion (RO)/preamble mapping. Detailed procedures of PRACH resource selection may be found in section 5.1.2 and 5.1.2a of 3GPP TS 38.321 for 4-step RACH and 2-step RACH, respectively.

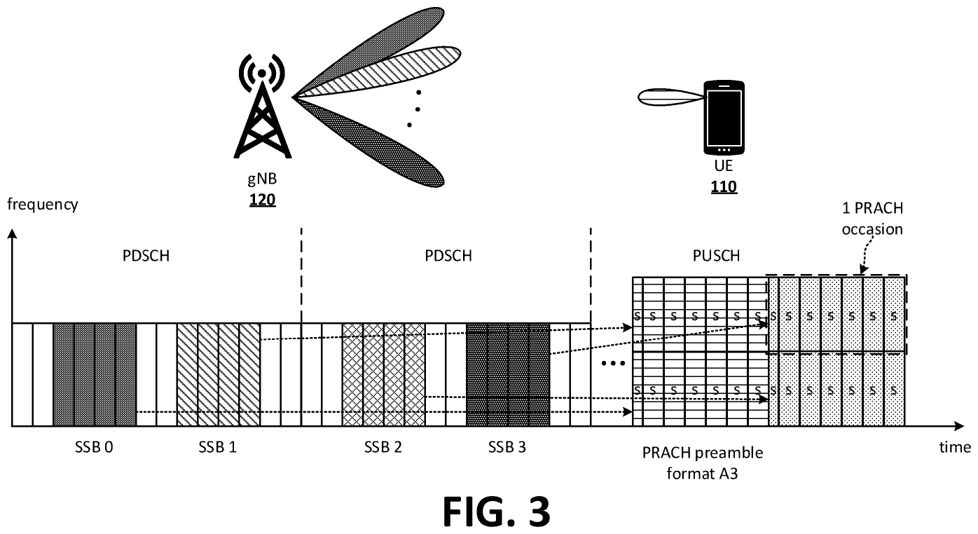

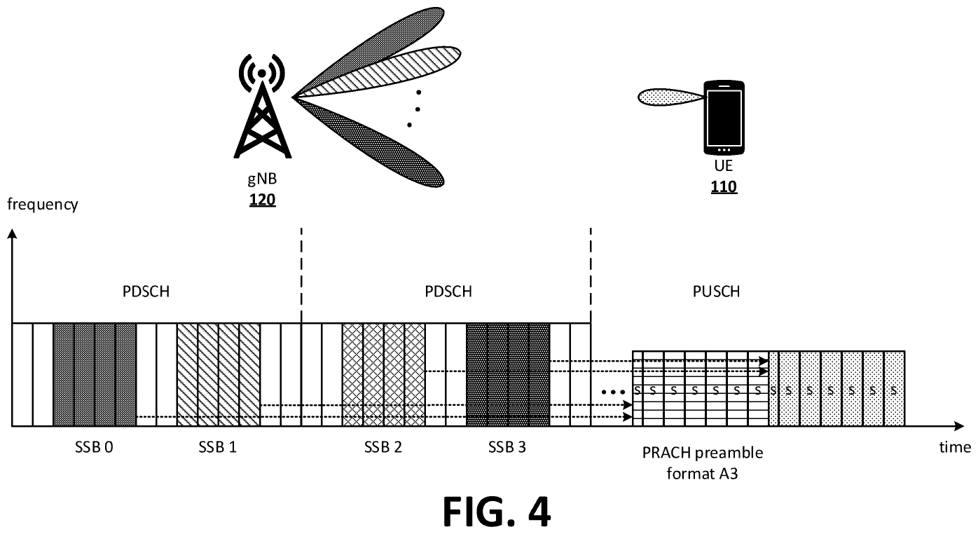

The mapping between SSB and PRACH may be one-to-one, one-to-many, and many-to-one in a predetermined order specified in standard. For example, FIG. 3 and FIG. 4 show exemplary one-to-one and many-to-one mapping between SSB and PRACH occasions, respectively.

When a UE (e.g., the UE 110) determines a good enough SSB beam with Synchronous Signal-Reference Signal Received Power (SS-RSRP) above an RSRP threshold (e.g., rsrp-ThresholdSSB), a preamble in the set of one or more preambles in a PRACH occasion mapped to this SSB may be selected for the random access, then when the gNB (e.g., the gNB 120) detects the preamble, the determined SSB beam for this UE may be known indirectly to some extent so that determined beam can be used for transmitting signals to or receiving signals from this UE.

FIG. 3 shows four SSBs (e.g., SSB 0, SSB1, SSB2, and SSB3) broadcasted by the gNB 120 and four PRACH occasions for the UE 110 to transmit its PRACH for its random access procedure. As shown in FIG. 3, there is one-to-one mapping between the four SSBs and four PRACH occasions, which is indicated by the arrows. After the UE 110 detects the four SSBs and select one of them, for example, the SSB with the highest SS-RSRP (e.g., SSB 1), the UE 110 may choose the PRACH occasion mapped to the SSB 1 for its PRACH transmission. By detecting the PRACH received over the PRACH occasion, the gNB 120 may determine which of the SSBs is selected by the UE 110 (i.e., SSB 1) and corresponding radio resources may be assigned accordingly based on this selection.

FIG. 4 shows four SSBs (e.g., SSB 0, SSB1, SSB2, and SSB3) broadcasted by the gNB 120 and two PRACH occasions for the UE 110 to transmit its PRACH for its random access procedure. As shown in FIG. 4, there is many-to-one mapping between the four SSBs and two PRACH occasions, which is indicated by the arrows. After the UE 110 detects the four SSBs and select one of them, for example, the SSB with the highest SS-RSRP (e.g., SSB 3), the UE 110 may choose the PRACH occasion mapped to the SSB 3 for its PRACH transmission. By detecting the PRACH received over the PRACH occasion, the gNB 120 may determine which ones of the SSBs are selected by the UE 110 (i.e., SSB2 or SSB3) and corresponding radio resources may be assigned accordingly based on this selection.

Please note that the present disclosure is not limited thereto. In some other embodiments, a different number of SSBs and/or a different number of PRACH occasions and/or a different mapping may be provided. Further, although it looks like, in FIG. 2 and FIG. 3, the SSBs and the PRACH occasions are located within a same frequency band, they actually may be not. In some embodiments, they may be located within different frequency bands, for example, different resource elements (REs), different resource blocks (RBs), different bandwidth parts (BWPs), or even different carriers.

ROs for a 2-step RACH may be either separately configured (also known as Type-2 random access procedure with separate configuration of PRACH occasions with Type-1 random access procedure) or are shared with a 4-step RACH (also known as Type-2 random access procedure with common configuration of PRACH occasions with Type-1 random access procedure). In the latter case, different sets of preamble IDs will be used.

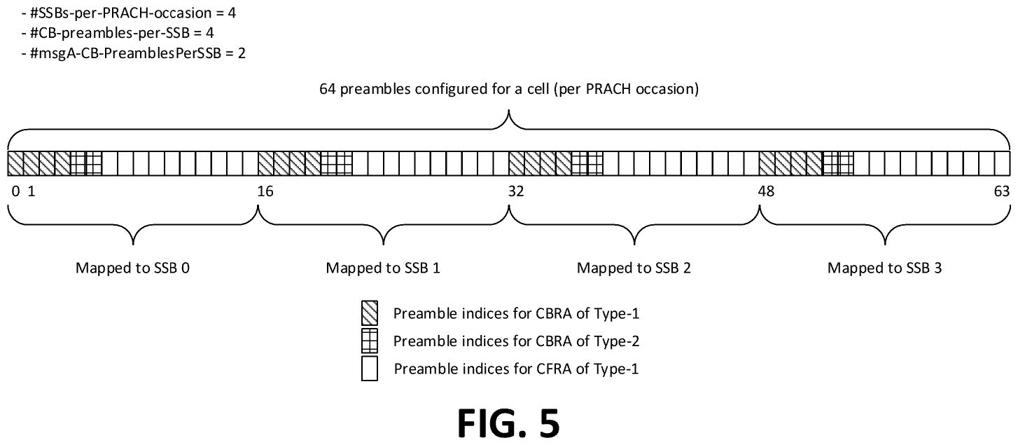

For a Type-2 random access procedure with common configuration of PRACH occasions with Type-1 random access procedure, a UE may be provided with a number N of SSBs associated with one PRACH occasion by ssb-perRACH-OccasionAndCB-PreamblesPerSSB and a number Q of contention based preambles per SSB per valid PRACH occasion by MsgA-CB-PreamblesPerSSB. The PRACH transmission can be on a subset of PRACH occasions associated with a same SSB index for a UE provided with a PRACH mask index by MsgA-ssb-sharedRO-MaskIndex. An example of the SSB to RO mapping and the preamble allocation is provided in FIG. 5. Note that only one preamble group is assumed in this example.

As shown in FIG. 5, a total of 64 preambles are configured for a cell. Based on the parameters broadcasted by a gNB (e.g., the gNB 120) and also shown at the upper left corner in FIG. 5, a UE (e.g., the UE 110) may determine how the preambles are grouped and their usages. For example, with the received parameter “#SSBs-per-PRACH-occasion=4”, the UE may determine that the 64 preambles are mapped to 4 SSBs, respectively, and therefore preambles 0-15 are mapped to SSB 0, preambles 16-31 are mapped to SSB 1, preambles 32-47 are mapped to SSB 2, and preambles 48-63 are mapped to SSB 3. Further, with the received parameter “#CB-preambles-per-SSB=4”, the UE may determine that first 4 preambles mapped to each SSB are used for CBRA of Type-1. Furthermore, with the received parameter “#msgA-CB-PreamblesPerSSB=2”, the UE may determine that the next 2 preambles mapped to each SSB are used for CBRA of Type-2. Finally, the UE may determine that the remaining preambles mapped to each SSB are used for CFRA of Type-1.

For a Type-2 random access procedure with separate configuration of PRACH occasions with Type-1 random access procedure, a UE may be provided with a number N of SSBs associated with one PRACH occasion and a number R of contention based preambles per SSB per valid PRACH occasion by msgA-SSB-PerRACH-OccasionAndCB-PreamblesPerSSB when provided; otherwise, by ssb-perRACH-OccasionAndCB-PreamblesPerSSB. Since the SSB to RO mapping and the preamble allocation are independently configured, the example provided for 4-step RACH in FIG. 5 may also be valid for this case of 2-step RACH except that the parameters are separately configured for 2-step RACH.

For both 2-step RACH and 4-step RACH, 2 preamble groups, group A and group B may be configured, such that the network can be made aware of that a greater TB size may be scheduled in a MsgA/Msg3 PUSCH transmission when a preamble in group B is detected by the network.

As mentioned above, CFRA is the mode where a UE performs random access in resources where there is no contention, i.e. the UE is specifically allocated a random access resource. In CFRA with 4-step RA type, the non-contention is ensured by providing the UE with one or a set of preambles and in CFRA with 2-step RA type, the non-contention is ensured by similarly providing the UE with one or a set of preambles as well as msgA PUSCH resources. CFRA may be used in a number of cases:
Handover (Reconfiguration with sync);
Beam Failure recovery (BFR);
System Information Request (SI Request); and/or
DL or UL data arrival during RRC_CONNECTED when UL synchronization status is “non-synchronized”.

As an example of handover, the source cell may in the handover command (also referred to as Reconfiguration with sync) provide the UE with a PRACH configuration along with a set of preambles, one for each SSB, to use for performing synchronization with the target cell (for example, seen in the 38.331 excerpt below). Typically, the PRACH configuration may be shared with CBRA and the preambles given in the handover command come from the set of 64 preambles at the end of the preamble range (preambles ranges {63-X, . . . , 63}). Alternatively as introduced in 5G NR, there is also the possibility to configure separate PRACH configuration only for CFRA, but this comes with increased resource usage as the CFRA resources need to be reserved at the target cell and is thus less likely to be used.

Excerpt from 3GPP TS 38.331 on CFRA used for handovers:

| | | |
|---|---|---|
| 1 | CFRA ::= | SEQUENCE { |
| 2 | occasions | SEQUENCE { |
| 3 | rach-ConfigGeneric | RACH-ConfigGeneric, |
| 4 | ssb-perRACH-Occasion | ENUMERATED {oneEighth, oneFourth, oneHalf, one, two, |

four, eight, sixteen}
5
OPTIONAL -- Cond Mandatory

| | |
|---|---|
| 6 | } |

OPTIONAL, -- Need S

| | | |
|---|---|---|
| 7 | resources | CHOICE { |
| 8 | ssb | SEQUENCE { |
| 9 | ssb-ResourceList | SEQUENCE (SIZE(1..maxRA-SSB-Resources)) OF CFRA- |

SSB-Resource,

| 10 | ra-ssb-OccasionMaskIndex | INTEGER (0..15) |
|---|---|---|
| 11 | }, | |
| 12 | csirs | SEQUENCE { |
| 13 | csirs-ResourceList | SEQUENCE (SIZE(1..maxRA-CSIRS-Resources)) OF |

CFRA-CSIRS-Resource,

| | | |
|---|---|---|
| 14 | rsrp-ThresholdCSI-RS | RSRP-Range |

| | |
|---|---|
| 15 | } |
| 16 | }, |
| 17 | ..., |
| 18 | [[ |
| 19 | totalNumberOfRA-Preambles INTEGER (1..63) |

OPTIONAL -- Cond Occasions

| | |
|---|---|
| 20 | ]] |
| 21 | } |

Another aspect to consider is that while there is a Msg3 defined for CBRA, there is formally no Msg3 for CFRA. Instead the third message in the CFRA procedures is either not part of the procedures, or the third message is considered to be “a PUSCH scheduled by UL grant in RAR”.

Further, a PDCCH with CRC scrambled by C-RNTI, as specified in 3GPP TS 38.212, may be used to trigger a CBRA or CFRA when e.g. the uplink timing sync is lost, or when establishing a timing advance on a secondary cell (for Carrier Aggregation).

If the CRC of the DCI format 1_0 is scrambled by C-RNTI and the “Frequency domain resource
assignment” field are of all ones, the DCI format 1_0 is for random access procedure initiated by a
PDCCH order, with all remaining fields set as follows:

| | |
|---|---|
| - | Random Access Preamble index - 6 bits according to ra-PreambleIndex in Clause 5.1.2 of [8, |
| | TS38.321] |
| - | UL/SUL indicator - 1 bit. If the value of the “Random Access Preamble index” is not all zeros and if |
| | the UE is configured with supplementaryUplink in ServingCellConfig in the cell, this field indicates |
| | which UL carrier in the cell to transmit the PRACH according to Table 7.3.1.1.1-1; otherwise, this |
| | field is reserved |
| - | SS/PBCH index - 6 bits. If the value of the “Random Access Preamble index” is not all zeros, this |
| | field indicates the SS/PBCH that shall be used to determine the RACH occasion for the PRACH |
| | transmission; otherwise, this field is reserved. |
| - | PRACH Mask index - 4 bits. If the value of the “Random Access Preamble index” is not all zeros, this |
| | field indicates the RACH occasion associated with the SS/PBCH indicated by “SS/PBCH index” for |
| | the PRACH transmission, according to Clause 5.1.1 of [8, TS38.321]; otherwise, this field is reserved |
| - | Reserved bits - 12 bits for operation in a cell with shared spectrum channel access; otherwise 10 bits |

CFRA may be triggered when the value of the “Random Access Preamble index” is not all zeros, while CBRA may be triggered when the value of the “Random Access Preamble index” is all zeros.

During the discussions in the meetings from 3GPP RAN1 #104-e, the first meeting of the NR coverage enhancement work item in Rel-17, to 3GPP RAN1 #105-e, following agreements have been made regarding the Msg3 repetition criteria:
UE determines a separate PRACH resource (separate preamble and/or separate PRACH occasions) based at least on RSRP of the downlink pathloss reference and the RSRP threshold;
Based on the PRACH resource on which a PRACH is detected, gNB is aware of whether a Msg3 repetition can be enabled for the UE sending this PRACH.

Based on the agreement, at least preamble partitioning or grouping (i.e., a separate group of preambles on the PRACH occasions shared with legacy PRACH transmission) will be supported for requesting Msg3 repetition.

Agreement: For Msg3 PUSCH repetition, support the following modified Option 2-1.
Option 2-1: For UE requested Msg3 PUSCH repetition with gNB indicating the number of repetitions,
   A UE can request Msg3 PUSCH repetition via separate PRACH resources (For further study (FFS) details, e.g., separate PRACH occasion or separate PRACH preamble in case of shared PRACH occasions after SSB association, etc.).
      Whether a UE would request is based on some conditions, e.g., measured SS-RSRP threshold, which may or may not have spec impact.
   If Msg3 PUSCH repetition is requested by UE, gNB decides whether to schedule Msg3 PUSCH repetition or not. If scheduled, gNB decides the number of repetitions for Msg3 PUSCH 3 (re)-transmission.
   FFS the UE capability of supporting Msg3 PUSCH repetition can be reported after initial access procedure as usual
   FFS details if any.

Agreement: A UE requests Msg3 PUSCH repetition at least when the RSRP of the downlink pathloss reference is lower than an RSRP threshold.
FFS the determination of the RSRP threshold.

Agreement:
For requesting Msg3 PUSCH repetition, support the following:
   Use separate preamble with shared RO configured by the same PRACH configuration index with legacy UEs.
      FFS whether to introduce a PRACH mask to indicate a sub-set of ROs associated with a same SSB index within an SSB-RO mapping cycle for requesting Msg3 repetition for a UE.
      FFS definition of shared RO (e.g., whether the shared RO can be an RO with preamble(s) for 4-step RACH only or with preambles for both 4-step RACH and 2-step RACH).
   FFS whether or not to additionally support one (& only one) more option:
      E.g., option 2: Use separate RO configured by a separate PRACH configuration index from legacy UEs
      E.g., Option 3: Use separate RO, which include
         the separate RO configured by a separate RACH configuration index from legacy UE, and
         the remaining RO (if any) configured, by the same PRACH configuration index with legacy UEs, that cannot be used by legacy rules for PRACH transmission.

For repetition of PUSCH scheduled by fallback RAR, it is still open and if supported no specific signaling optimization will be used according to following agreements made in RAN1 #104-e meeting:

Agreements:
For indication of the number of repetitions for Msg3 initial transmission, down-select one option from the options below.
   Option1: UL grant scheduling Msg3.
      FFS details.
      FFS fallbackRAR UL grant.
      Note: Optimization specific for fallbackRAR UL grant in 2-step RACH is not considered in Rel-17 CovEnh WI, if supported.
   Option2: DCI format 1_0 with CRC scrambled by RA-RNTI
      FFS details.
   Option3: SIB1 only

For PUSCH scheduled by RAR in CFRA, following agreement was made during NR coverage enhancement study item in RAN1 #102-e meeting:

Agreements:
Enhancement to PUSCH scheduled by RAR UL grant will not consider the optimization specific for CFRA case in NR coverage SI.

This means that repetition of PUSCH scheduled by RAR in CFRA will be supported with similar signaling methods indicated by RAR.

When performing CBRA for 4-step random access, a UE that is capable of performing Msg3 repetition will choose between signaling either that repetition for Msg3 is not needed or that it is needed through the use of PRACH resources. This means that when the Msg2 is received, the UE will know whether the Msg2 should be interpreted as the legacy Msg2 or the new Msg2 used for signaling of Msg3 repetitions.

When performing CFRA and needing to perform repetitions for the third message in the CFRA procedure, it is not clear whether the UE shall perform selection between different PRACH resources as is done for CBRA.

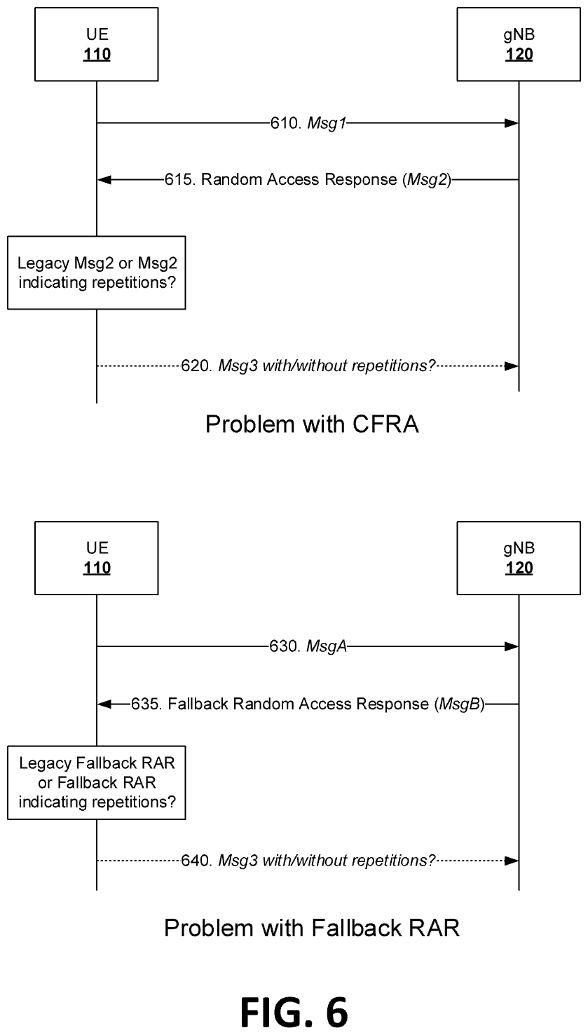

In one CFRA case, in the case of handover, the network (source cell in the case of handover) may already know whether repetitions in the third message of the random access procedure would be beneficial with the target cell but it is still up to the target cell to decide. The problem with some of these approaches is that if the UE has not been able to choose any PRACH resources, it would not know what type of Msg2 that it shall attempt to decode/interpret, since a new Msg2 (or at least a new interpretation of one or multiple fields of msg2 (DCI and/or RAR), for instance a new TDRA table/list with repetition factor may be used by the PUSCH time resource allocation field in RAR UL grant when repetition of the PUSCH scheduled by RAR is expected) would be needed to signal that repetitions for third message during the random access procedure shall be performed, as shown in the top portion of FIG. 6.

When a UE initially performs 2-step RACH, the network may send a fallback RAR (for instance after a number of times of failure in 2-step RA) to force UE to switch from 2-step RA to 4-step RA, fallback RAR will then schedule a Msg3. In this case, the gNB may not be able to know whether such Msg3 can be scheduled to be repeated or not if there is no separate PRACH resource configured in 2-step RACH to indicate the UE capability of Msg3 repetition, as shown in the bottom portion of FIG. 6.

Therefore, there is a problem of how would know how to interpret Msg2 (DCI and/or RAR) or determine repetitions when not having signaled that repetitions are needed through PRACH selection.

Some embodiments of the present disclosure provide methods on how to determine the repetition of PUSCH scheduled by RAR in CFRA with 4-step RA type or by fallback RAR when UE fallbacks from 2-step RA to 4-step RA. Some embodiments of the present disclosure may provide:
Signaling in CFRA configuration that a UE shall interpret Msg2 as either legacy or signaling repetitions; and/or
Signaling for fallback from 2-step RA whether a UE shall interpret Msg2 as either legacy or signaling repetitions.

With the methods provided, the gNB and UE may be aligned on whether a msg3 repetition should be scheduled by a fallback RAR or a PUSCH scheduled by RAR in CFRA with 4-step RA type should be repeated or not.

In some embodiments, the term “PUSCH scheduled by RAR in CFRA” may refer to a PUSCH scheduled by the UL grant provided in the random access response message in contention free random access procedure. In some embodiments, the term “PUSCH scheduled by fallback RAR” or “Msg3 scheduled by fallback RAR” may refer to the PUSCH transmission scheduled by the UL grant provided in fallback RAR message when a UE fallbacks from 2-step RA to 4-step RA, where the 2-step RA can be either a contention free random access procedure or a contention based random access procedure. In some embodiments, PRACH resource may be the PRACH time-frequency resources and/or PRACH preamble sequences.

Also note that Msg2 usually (the terminology is often sloppily used even among experts) encompasses both DCI and RAR. When RAR is used, it may be specifically meant to point to either RAR or fallback RAR. When changes related to Msg2 are used, it may mean that changes to DCI and/or RAR could be introduced. While it is more likely from a standardization that changes to RAR may be introduced, the present disclosure is not limited to RAR only, as DCI could technically also be used to indicate this.

In CFRA with 4-step RA type, the PUSCH scheduled by RAR may be repeated or not repeated can be based on one or more of the methods provided in embodiments below.

In some embodiments, a network (e.g., the gNB 120) may signal whether the UE (e.g., the UE 110) shall attempt to decode the Msg2 as being for performing PUSCH repetitions, or whether it shall attempt to decode the Msg2 in legacy way without PUSCH repetition. This option may allow for flexibility in how the network uses repetitions scheduled by Msg2.

In some embodiments, this signaling may be a flag in the CFRA configuration indicating that the UE shall attempt to decode in the Msg2 in a specific manner. This can allow for flexible signaling of repetitions for PUSCH for each CFRA case depending on whether the UE is for instance performing BFR or handover. An example of this may be seen in following text proposal #1.

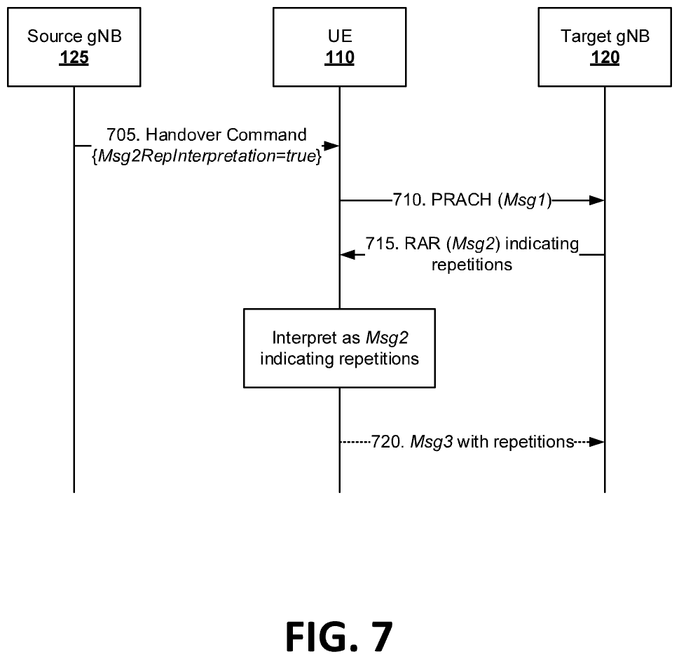

In some embodiments, for handover, the flag may for instance be a part of the handover command (e.g., received from the source cell to perform random access to the target cell) where the source cell detects that the UE is in rather poor coverage thus repetitions for PUSCH is likely to be needed. An example of this is shown in FIG. 7.

FIG. 7 is a flow chart illustrating an exemplary procedure for feature based random access according to an embodiment of the present disclosure. As shown in FIG. 7, a UE 110 may be instructed to perform a handover to a target gNB 120 by its source gNB 125 with a Handover Command at step 705. The Handover Command may comprise a field “Msg2RepInterpretation=true” to indicate that the UE shall interpret the Msg2 received from the target gNB 120 as for indicating uplink resource for Msg3 repetition.

Upon reception of the Handover Command, the UE 110 may transmit a PRACH to the target gNB 120 for initiating a CFRA procedure with 4-step RA type at step 710. At step 715, the UE 110 may receive a Msg2 comprising RAR for scheduling its Msg3 transmission. Based on the field “Msg2RepInterpretation=true” received at step 705, the UE may determine that the RAR received at step 715 may be interpreted as for indicating uplink resource for Msg3 repetition, rather than uplink resource for legacy Msg3 transmission, and it may determine the correct uplink resource accordingly.

At step 720, the UE 110 may transmit its Msg3 with repetitions to the gNB 120 and perform all other potential operations for the CFRA procedure.

In some embodiments, for BFR, the configuration may for instance be such that the UE shall always attempt to decode the Msg2 as using repetitions, while for handovers the UE shall always attempt to decode the Msg2 as not signaling repetitions.

In some embodiments, for the CFRA, the preamble index may indicate whether the UE shall decode the Msg2 in a specific manner.

In some embodiments, this signaling may for instance be a flag provided in dedicated RRC signaling or in MAC CE or in system information. As an example, a “PUSCH repetition flag” field may be semi-statically configured in PUSCH-Config 1E to indicate whether RAR should be interpreted in a way assuming that the PUSCH scheduled by RAR may be repeated or not.

In some embodiments, in the random access configuration of the target cell there may be a flag that the UE shall always attempt to decode the Msg2 as a repetition for PUSCH if the UE has the capability to do so.

In some embodiments, in case of PDCCH ordered CFRA, this signaling can for instance be a flag provided in DCI ordering the CFRA. As an example, a “PUSCH repetition flag” field can be defined in DCI format 1_0 to indicate whether RAR should be interpreted in a way assuming that the PUSCH scheduled by RAR may be repeated or not. An exemplary embodiment may be seen in the following text proposal #2.

In the example in the text proposal #2, supposing the PUSCH repetition factors are defined in a new TDRA table which may be used by the “PUSCH time resource allocation” field in RAR when repetition of PUSCH scheduled by RAR is enabled, and a legacy TDRA table may be used when the repetition PUSCH scheduled by RAR is disabled, when “PUSCH repetition flag” received in a PDCCH order is set to 1, UE may assume the new TDRA table should be assumed to be used when interpreting the “PUSCH time resource allocation” field in RAR UL grant.

In some embodiments, the UE shall attempt to decode the Msg2 as being for performing PUSCH repetitions, or whether it shall attempt to decode the msg2 in legacy way without PUSCH repetition based on UE capability of doing msg3 repetition and/or repetition of PUSCH scheduled by RAR, wherein the UE capability is reported to network in RRC connected state. This means that once a UE reports to the network that it supports msg3 repetition and/or the repetition of a PUSCH scheduled by RAR, UE should interpret the msg2 assuming repetition of PUSCH scheduled by RAR may be signaled by the network. Otherwise, UE would interpret the Msg2 assuming repetition of PUSCH scheduled by RAR is not signaled, i.e. the legacy Msg2 should be interpreted.

In some embodiments, the UE shall attempt to decode the Msg2 as being for performing PUSCH repetitions, or whether it shall attempt to decode the Msg2 in legacy way without PUSCH repetition based on the CFRA PRACH resource selected. As an example, CFRA preambles allocated to the UE for CFRA can be in 2 sets, and transmission of a preamble in one preamble set indicates that PUSCH repetition is requested while transmission of a preamble in the other preamble set indicates that PUSCH repetition is not requested. A threshold can thus be included similar to in CBRA where one set of CFRA preambles are selected in case the RSRP or pathloss is above the configured threshold, or the same threshold as used for CBRA can be used.

In some embodiments, when no signaling from network side is defined or when the signaling from the network is optional and absent, the UE shall attempt to decode both the Msg2 as being for performing PUSCH repetitions, and the Msg2 in legacy way without PUSCH repetition. In this case, UE may need to do repetition if repetition is enabled when decoding the Msg2 as being for performing PUSCH repetitions, as long as UE supports repetition of PUSCH scheduled by RAR. Otherwise, PUSCH repetition will not be performed. This might be fine since a PUSCH retransmission may be triggered if the network fails in decoding the PUSCH scheduled by RAR.

In some embodiments, for PUSCH scheduled by RAR in CFRA, the UE shall always attempt to decode the Msg2 in legacy way without PUSCH repetition. This method means that PUSCH repetition when scheduled by RAR in CFRA is not supported.

In some embodiments, the network may send both Msg2 indicating PUSCH repetitions and a legacy Msg2. This is a network-based solution that allows the UEs with the right capability to perform repetitions if they are capable, and not perform repetitions if they are incapable. In this case the Msg2 indicating PUSCH repetitions would first be sent by the network and be attempted to be decoded by the UE and then the legacy Msg2 would be sent. The order can be standardized, i.e. that the UE shall first attempt to decode a Msg2 indicating repetitions and then decode a legacy Msg2 if the first one fails.

When UE fallbacks from 2-step RACH (could be an CFRA or a CBRA) to 4-step RACH, whether the msg3 should be assumed to be repeated or not and whether the fallback RAR should be interpreted in a way assuming msg3 repetition may be enabled or not can be based on one or more of the following methods provided in the embodiments in some embodiments described below. Please note that while fallback RAR is described here, there could also be changes to DCI introduced as well-however there is no “fallback DCI” or “fallback Msg2”.

In some embodiments, for fallback from CFRA with 2-step RA type to 4-step RA, the network may signal whether it is fallback RAR indicating PUSCH repetition fallback or legacy fallback. This allows a network to perform fallback from 2-step to 4-step with PUSCH repetitions, because without this signaling it is likely that only 4-step without PUSCH repetitions would only be possible.

In some embodiments, the signaling can be provided in one or more of the following ways:
CFRA configuration of the target gNB sent by the source gNB will indicate whether the UE shall interpret the fallback RAR as indicating PUSCH repetitions. One example is seen in the Text proposal #1.
This signaling can for instance be a flag provided in DCI ordering the CFRA.
   The example of PDCCH ordered CFRA provided above can be used here as well for the PDCCH ordered CFRA with 2-step RA type.
A flag provided in dedicated RRC signaling (i.e. in the configuration where the CFRA is configured) or in MAC CE or in system information.

In some embodiments, for fallback from CFRA with 2-step RA type to 4-step RA, the UE shall attempt to decode the fallback RAR as being for performing PUSCH repetitions, or whether it shall attempt to decode the fallback RAR in legacy way without PUSCH repetition based on the PRACH resource selected for the CFRA with 2-step RA type. As an example, CFRA preambles allocated to the UE for CFRA with 2-step RA type can be in 2 sets, and transmission of a preamble in one preamble set indicates that PUSCH repetition is requested while transmission of a preamble in the other preamble set indicates that PUSCH repetition is not requested, wherein the PUSCH is the PUSCH scheduled by fallback RAR.

In some embodiments, for fallback from CFRA with 2-step RA type to 4-step RA, the UE shall attempt to decode the fallback RAR as being for scheduling PUSCH repetitions, or whether it shall attempt to decode the fallback RAR in legacy way without PUSCH repetition based on UE capability of doing msg3 repetition and/or repetition of PUSCH scheduled by RAR, wherein the UE capability is reported to network in RRC connected state. This means that once a UE reports to the network that it supports msg3 repetition and/or the repetition of a PUSCH scheduled by fallback RAR, UE should interpret the fallback RAR assuming repetition of PUSCH scheduled by RAR may be signaled by the network. Otherwise, UE would interpret the fallback RAR assuming repetition of PUSCH scheduled by fallback RAR is not signaled, i.e. the legacy RAR without scheduling a PUSCH repetition should be interpreted.

In some embodiments, for fallback from CBRA with 2-step RA type to 4-step RA, the network may signal whether it is fallback RAR indicating PUSCH repetition fallback or legacy fallback in one or more of the following methods:
the signaling is in system information
   In this case, all UEs may have to interpret the fallback RAR when the signaling indicates the fallback RAR is expected to be interpreted assuming msg3 repetition may be scheduled.
it is specifically configured by the network
   This can be done when the UE is in connected mode and performs random access.

In above embodiments, since in CBRA, UE is not known by gNB and dedicated signaling may only be used in connected mode to signal the type of fallback RAR.

In some embodiments, for fallback from CBRA with 2-step RA type to 4-step RA, the UE shall attempt to decode the fallback RAR as being for performing PUSCH repetitions, or whether it shall attempt to decode the fallback RAR in legacy way without PUSCH repetition based on the PRACH resource selected for CBRA with 2-step RA type. As an example, CBRA preambles allocated to the UE for CBRA with 2-step RA type can be in 2 sets, and transmission of a preamble in one preamble set indicates that PUSCH repetition is requested while transmission of a preamble in the other preamble set indicates that PUSCH repetition is not requested, wherein the PUSCH is the PUSCH scheduled by fallback RAR.

In some embodiments, for fallback from CBRA with 2-step RA type to 4-step RA, and/or for fallback from CFRA with 2-step RA type to 4-step RA, no signaling from network side is defined or when the signaling from the network is optional and absent, the UE shall attempt to decode both the fallback RAR as being for scheduling PUSCH repetitions, and the fallback RAR in legacy way without scheduling PUSCH repetition. In this case, UE may need to do repetition if repetition is enabled when decoding the fallback RAR as being for scheduling PUSCH repetitions, as long as UE supports repetition of PUSCH scheduled by fallback RAR. Otherwise, PUSCH repetition will not be transmitted by UE. This might be fine since a PUSCH retransmission may be triggered if the network fails in decoding the PUSCH scheduled by fallback RAR.

In some embodiments, for fallback from CBRA with 2-step RA type to 4-step RA, and/or for fallback from CFRA with 2-step RA type to 4-step RA, the UE shall always attempt to decode the fallback RAR in legacy way without scheduling PUSCH repetition. In this method, it means fallback RAR scheduled msg3 will not be allowed to be repeated and a retransmission of such msg3 may be needed when the link quality is low.

In some embodiments, for fallback from CBRA and CFRA with 2-step RA type, the network will send both fallback RAR indicating PUSCH repetitions and a legacy fallback RAR. This is a network-based solution that allows the UEs with the right capability to perform repetitions if they are capable, and not perform repetitions if they are incapable. In this case the fallback RAR indicating PUSCH repetitions would first be sent by the network and be attempted to be decoded by the UE and then the legacy fallback RAR would be sent. The order can be standardized, i.e. that the UE shall first attempt to decode a fallback RAR indicating repetitions and then decode a legacy fallback RAR.

Text proposal #1
From 3GPP TS 38.331:
- RACH-ConfigDedicated
The IE RACH-ConfigDedicated is used to specify the dedicated random access parameters.
RACH-ConfigDedicated information element

-- ASN1START
-- TAG-RACH-CONFIGDEDICATED-START

| RACH-ConfigDedicated ::= | SEQUENCE { | |
|---|---|---|
| cfra | CFRA | OPTIONAL, -- Need S |
| ra-Prioritization | RA-Prioritization | OPTIONAL, -- Need N |

```
  ...,
  [[
```

| | | |
|---|---|---|
| ra-PrioritizationTwoStep-r16 | RA-Prioritization | OPTIONAL, -- Need N |
| cfra-TwoStep-r16 | CFRA-TwoStep-r16 | OPTIONAL -- Need S |

```
  ]],
  [[
```

| | |
|---|---|
| msg2-TypeInterpretation | ENUMERATED {legacyMsg2, repetitionMsg2} |

]]
}

| CFRA ::= | SEQUENCE { | |
|---|---|---|
| occasions | SEQUENCE { | |
| rach-ConfigGeneric | RACH-ConfigGeneric, | |
| ssb-perRACH-Occasion | ENUMERATED {oneEighth, oneFourth, oneHalf, one, two, | |
| four, eight, sixteen} | | OPTIONAL -- Cond Mandatory |
| } | | OPTIONAL, -- Need S |

| | |
|---|---|
| resources | CHOICE { |
| ssb | SEQUENCE { |
| ssb-ResourceList | SEQUENCE (SIZE(1..maxRA-SSB-Resources)) OF CFRA-SSB- |

Resource,

| | |
|---|---|
| ra-ssb-OccasionMaskIndex | INTEGER (0..15) |

},

| | |
|---|---|
| csirs | SEQUENCE { |
| csirs-ResourceList | SEQUENCE (SIZE(1..maxRA-CSIRS-Resources)) OF CFRA- |

CSIRS-Resource,

| | |
|---|---|
| rsrp-ThresholdCSI-RS | RSRP-Range |

```
    }
  },
  ...,
  [[
```

| | |
|---|---|
| totalNumberOfRA-Preambles INTEGER (1..63) | OPTIONAL -- Cond Occasions |

]]
}

| | |
|---|---|
| CFRA-TwoStep-r16 ::= | SEQUENCE { |
| occasionsTwoStepRA-r16 | SEQUENCE { |
| rach-ConfigGenericTwoStepRA-r16 | RACH-ConfigGenericTwoStepRA-r16, |
| ssb-PerRACH-OccasionTwoStepRA-r16 | ENUMERATED {oneEighth, oneFourth, oneHalf, one, |

two, four, eight, sixteen}

| } | | OPTIONAL, -- Need S |
|---|---|---|
| msgA-CFRA-PUSCH-r16 | MsgA-PUSCH-Resource-r16, | |
| msgA-TransMax-r16 | ENUMERATED {n1, n2, n4, n6, n8, n10, n20, n50, n100, | |
| n200} | | OPTIONAL, -- Need S |

| | |
|---|---|
| resourcesTwoStep-r16 | SEQUENCE { |
| ssb-ResourceList | SEQUENCE (SIZE(1..maxRA-SSB-Resources)) OF CFRA- |

SSB-Resource,

| | |
|---|---|
| ra-ssb-OccasionMaskIndex | INTEGER (0..15) |

```
  },
  ...
}
```

| | |
|---|---|
| CFRA-SSB-Resource ::= | SEQUENCE { |
| ssb | SSB-Index, |
| ra-PreambleIndex | INTEGER (0..63), |

```
  ...,
  [[
```

| | | |
|---|---|---|
| msgA-PUSCH-Resource-Index-r16 | INTEGER (0..3071) | OPTIONAL -- Cond 2StepCFRA |

]]
}

| | |
|---|---|
| CFRA-CSIRS-Resource ::= | SEQUENCE { |
| csi-RS | CSI-RS-Index, |
| ra-OccasionList | SEQUENCE (SIZE(1..maxRA-OccasionsPerCSIRS)) OF INTEGER |

(0..maxRA-Occasions-1),

| | |
|---|---|
| ra-PreambleIndex | INTEGER (0..63), |

...
}
-- TAG-RACH-CONFIGDEDICATED-STOP
-- ASN1STOP
CFRA-CSIRS-Resource field descriptions
csi-RS
The ID of a CSI-RS resource defined in the measurement object associated with this serving cell.
ra-OccasionList
RA occasions that the UE shall use when performing CF-RA upon selecting the candidate beam identified by this
CSI-RS. The network ensures that the RA occasion indexes provided herein are also configured by prach-
ConfigurationIndex and msg1-FDM. Each RACH occasion is sequentially numbered, first, in increasing order of
frequency resource indexes for frequency multiplexed PRACH occasions; second, in increasing order of time
resource indexes for time multiplexed PRACH occasions within a PRACH slot and Third, in increasing order of
indexes for PRACH slots.
ra-PreambleIndex
The RA preamble index to use in the RA occasions associated with this CSI-RS.
CFRA field descriptions
occasions
RA occasions for contention free random access. If the field is absent, the UE uses the RA occasions configured in
RACH-ConfigCommon in the first active UL BWP.
ra-ssb-OccasionMaskIndex
Explicitly signalled PRACH Mask Index for RA Resource selection in TS 38.321 [3]. The mask is valid for all SSB
resources signalled in ssb-ResourceList.
rach-ConfigGeneric
Configuration of contention free random access occasions for CFRA. The UE shall ignore
preambleReceivedTargetPower, preambleTransMax, powerRampingStep, ra-ResponseWindow signaled within this
field and use the corresponding values provided in RACH-ConfigCommon.
ssb-perRACH-Occasion
Number of SSBs per RACH occasion.
totalNumberOfRA-Preambles
Total number of preambles used for contention free random access in the RACH resources defined in CFRA,
excluding preambles used for other purposes (e.g. for SI request). If the field is absent but the field occasions is
present, the UE may assume all the 64 preambles are for RA. The setting should be consistent with the setting of ssb-
perRACH-Occasion, if present, i.e. it should be a multiple of the number of SSBs per RACH occasion.
CFRA-SSB-Resource field descriptions
msgA-PUSCH-Resource-Index
Identifies the index of the PUSCH resource used for MSGA CFRA. The PUSCH resource index indicates a valid
PUSCH occasion (as specified in TS 38.213 [13], subclause 8.1A) and the associated DMRS resources
corresponding to a PRACH slot. The PUSCH resource indexes are sequentially numbered and are mapped to valid
PUSCH occasions corresponding to a PRACH slot which are ordered, first, in increasing order of frequency resource
indexes for frequency multiplexed PUSCH occasions; second, in increasing order of DMRS resource indexes within a
PUSCH occasion, where a DMRS resource index DMRS_{id} is determined first in an ascending order of a DMRS port
index and then in an ascending order of a DMRS sequence index, third in increasing order of time resource indexes
for time multiplexed PUSCH occasions within a PUSCH slot and fourth, in increasing order of indexes for PUSCH
slots. For the case of contention free 2-step random access type, if this field is absent, the UE shall use the value 0.
ra-PreambleIndex
The preamble index that the UE shall use when performing CF-RA upon selecting the candidate beams identified by
this SSB.
ssb
The ID of an SSB transmitted by this serving cell.
CFRA-TwoStep field descriptions
msgA-CFRA-PUSCH
PUSCH resource configuration(s) for msgA CFRA.
msgA-TransMax
Max number of MsgA preamble transmissions performed before switching to 4-step type random access (see TS
38.321 [3], clauses 5.1.1). This field is only applicable when 2-step and 4-step RA type are configured and switching
to 4-step type RA is supported. If the field is absent in RACH-ConfigDedidated, switching from 2-step RA type to 4-
step RA type is not allowed.
occasionsTwoStepRA
RA occasions for contention free random access. If the field is absent, the UE uses the RA occasions configured in
RACH-ConfigCommonTwoStepRA in the first active UL BWP.
ra-SSB-OccasionMaskIndex
Explicitly signalled PRACH Mask Index for RA Resource selection in TS 38.321 [3]. The mask is valid for all SSB
resources signalled in ssb-ResourceList.
rach-ConfigGenericTwoStepRA
Configuration of contention free random access occasions for CFRA 2-step random access type.
ssb-PerRACH-OccasionTwoStep
Number of SSBs per RACH occasion for 2-step random access type.
RACH-ConfigDedicated field descriptions
cfra
Parameters for contention free random access to a given target cell. If this field and cfra-TwoStep are absent, the UE
performs contention based random access.
cfra-TwoStep
Parameters for contention free 2-step random access type to a given target cell. Network ensures that cfra and cfra-
TwoStep are not configured at the same time. If this field and cfra are absent, the UE performs contention based
random access. This field may only be present if msgA-ConfigCommon is configured on the BWP.
ra-prioritization
Parameters which apply for prioritized random access procedure to a given target cell (see TS 38.321 [3], clause
5.1.1).
ra-PrioritizationTwoStep
Parameters which apply for prioritized 2-step random access type procedure to a given target cell (see TS 38.321 [3],
clause 5.1.1).
msg2-TypeInterpretation
Indicates if the UE shall attempt to interpret RAR/Msg2 or fallback RAR [1] as legacy Msg2 or Msg2 indicating
repetitions.

| Conditional | |
|---|---|
| Presence | Explanation |
| Mandatory | The field is mandatory present. |
| Occasions | The field is optionally present, Need S, if the field occasions is present, otherwise it is absent. |
| 2StepCFRA | The field is optionally present for the case of 2-step RA type contention free random access, |
| | Need S, otherwise it is absent. |

Text Proposal #2
From 3GPP TS 38.212:

If the CRC of the DCI format 1_0 is scrambled by C-RNTI and the ″Frequency domain resource
assignment″ field are of all ones, the DCI format 1_0 is for random access procedure initiated by a
PDCCH order, with all remaining fields set as follows:

| | |
|---|---|
| - | Random Access Preamble index - 6 bits according to ra-PreambleIndex in Clause 5.1.2 of [8, |
| | TS38.321] |
| - | UL/SUL indicator - 1 bit. If the value of the ″Random Access Preamble index″ is not all zeros and if |
| | the UE is configured with supplementaryUplink in ServingCellConfig in the cell, this field indicates |
| | which UL carrier in the cell to transmit the PRACH according to Table 7.3.1.1.1-1; otherwise, this |
| | field is reserved |
| - | SS/PBCH index - 6 bits. If the value of the ″Random Access Preamble index″ is not all zeros, this |
| | field indicates the SS/PBCH that shall be used to determine the RACH occasion for the PRACH |
| | transmission; otherwise, this field is reserved. |
| - | PRACH Mask index - 4 bits. If the value of the ″Random Access Preamble index″ is not all zeros, this |
| | field indicates the RACH occasion associated with the SS/PBCH indicated by ″SS/PBCH index″ for |
| | the PRACH transmission, according to Clause 5.1.1 of [8, TS38.321]; otherwise, this field is reserved |
| - | PUSCH repetition flag - 1 bit. If the value of the “PUSCH repetition flag” is 0, UE monitors the |
| | random access response message assuming PUSCH scheduled by RAR is not repeated. Otherwise, UE |
| | assumes the PUSCH scheduled by RAR may be repeated. |
| - | Reserved bits - 11 bits for operation in a cell with shared spectrum channel access; otherwise 10 bits |

The term “feature” used herein may refer to any function, operation, step, resource, format, rule, and/or standard or the like that is used, performed, executed, enforced, or otherwise involved by UE, a RAN node, any other node, or a combination thereof, to achieve some effect.

In some embodiments, when multiple features (e.g., those mentioned above) are requested/indicated by different PRACH preambles, the preamble allocations for indication of multiple features may be in the order of increasing number of preamble IDs wherein the order may be either RRC configured or predetermined.

In some embodiments, when multiple features (e.g., those mentioned above) are requested/indicated by different PRACH preambles, a group of preambles may be used for indicating more than one features, which can be RRC configured or predetermined. This can be used to reduce the resource overhead for indicating multiple features especially when the number of features is quite great while the PRACH resources overhead is expensive.

In some embodiments, the expression “determining that a message A shall be decoded as for scheduling transmission of a message B with a feature performed” may cover the case where the feature is not actually enabled or the feature is performed to a minimum extent while the message A is still encoded and decoded as if the feature is performed. For example, when the feature involved is Msg3 repetition, if the UE determines that a Msg2 received in a CFRA procedure with 4-step RA type or a fallback RAR received in a fallback from 2-step RA to 4-step RA shall be decoded as for scheduling transmission of a Msg3 with repetitions, the UE may decode the Msg2 in a way that Msg3 repetitions will be performed later, even if the UE finally finds that the Msg2 indicates a Msg3 repetition factor of 1 which means no Msg3 repetition is needed. In such a case, the UE can still be described as “determining that the Msg2 shall be decoded as for scheduling transmission of the Msg3 with Msg3 repetition performed”. This is also applicable to the network side (e.g., a gNB).

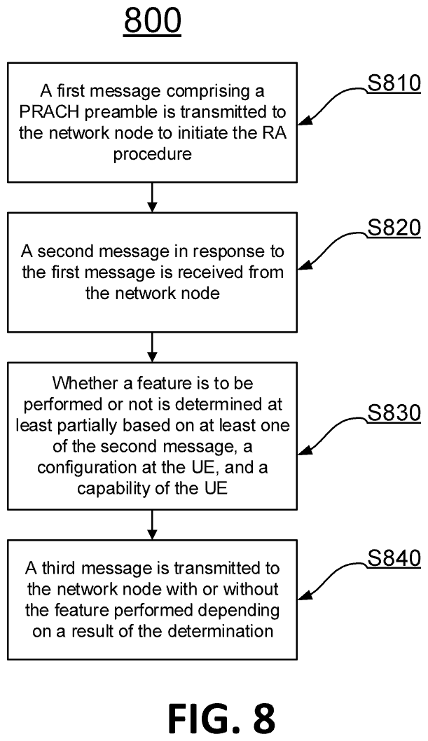

FIG. 8 is a flow chart of an exemplary method 800 at a UE for feature based random access according to an embodiment of the present disclosure. The method 800 may be performed at a user equipment (e.g., the UE 110). The method 800 may comprise step S810, S820, S830, and step S840. However, the present disclosure is not limited thereto. In some other embodiments, the method 800 may comprise more steps, less steps, different steps, or any combination thereof. Further the steps of the method 800 may be performed in a different order than that described herein. Further, in some embodiments, a step in the method 800 may be split into multiple sub-steps and performed by different entities, and/or multiple steps in the method 800 may be combined into a single step.

The method 800 may begin at step S810 where a first message comprising a PRACH preamble may be transmitted to the network node to initiate the RA procedure.

At step S820, a second message in response to the first message may be received from the network node.

At step S830, whether a feature is to be performed or not may be determined at least partially based on at least one of the second message, a configuration at the UE, and a capability of the UE.

At step S840, a third message may be transmitted to the network node with or without the feature performed depending on a result of the determination.

In some embodiments, the feature may comprise at least one of: Msg3 repetition; repetition for uplink transmission scheduled by the second message; a network slice; SDT; a RedCap UE; a random access in non-terrestrial network; and a specific service type or UE priority. In some embodiments, the second message may comprise a RAR and/or a DCI, wherein the step of determining whether a feature is to be performed or not may comprise: determining whether the feature is to be performed or not at least partially based on at least one of the configuration at the UE, the capability of the UE, the RAR, and the DCI. In some embodiments, the RA procedure may be a CFRA procedure.

In some embodiments, before the step S830, the method 800 may further comprise: receiving the configuration indicating whether the second message shall be decoded as for scheduling the transmission of the third message with or without the feature performed. In some embodiments, the configuration may be a flag in a CFRA configuration indicating whether the second message shall be decoded as for scheduling the transmission of the third message with or without the feature performed.

In some embodiments, when the RA procedure is initiated for BFR, the configuration may indicate that the second message shall always be decoded as for scheduling the transmission of the third message with the feature performed. In some embodiments, when the RA procedure is initiated for a handover, the configuration may indicate that the second message shall always be decoded as for scheduling the transmission of the third message with the feature performed. In some embodiments, the flag may be carried by a handover command received from another network node. In some embodiments, the configuration may be a preamble index, which is signaled to the UE for its PRACH transmission, indicating whether the second message shall be decoded as for scheduling the transmission of the third message with or without the feature performed.

In some embodiments, the configuration may be received via at least one of: dedicated RRC signaling; MAC CE; and broadcasted system information. In some embodiments, the configuration may be received from the network node, wherein the configuration may indicate that the second message shall always be decoded as for scheduling the transmission of the third message with the feature performed in response to determining that the capability of the UE supports the feature. In some embodiments, the configuration may be a flag in a DCI that orders the UE to initiate the RA procedure. In some embodiments, the flag may indicate whether a legacy TDRA table or another TDRA table for enabling the feature shall be used for scheduling uplink resource for transmission of the third message. In some embodiments, before S820, the method 800 may further comprise: transmitting, to the network node, a capability indicator indicating the capability of the UE, wherein the step S830 may comprise: determining whether the second message shall be decoded as for scheduling the transmission of the third message with or without the feature performed based on the capability of the UE.

In some embodiments, before the step S810, the method 800 may further comprise: receiving an indicator indicating at least two sets of PRACH resources that comprise a first set indicating that the feature is requested by the UE and a second set indicating that the feature is not requested by the UE, wherein the step S810 may comprise: transmitting the first message by using a PRACH resource that is selected from the first set or the second set depending on whether the feature is to be requested or not by the UE, wherein the step S830 may comprise: determining whether the second message shall be decoded as for scheduling the transmission of the third message with or without the feature performed based on from which of the first set and the second set the PRACH resource is selected.

In some embodiments, whether the feature is to be requested or not by the UE may be determined by: measuring RSRP of downlink pathloss reference; comparing the measured RSRP with a configured threshold; determining that the feature is to be requested in response to determining that the measure RSRP is lower than the configured threshold; and determining that the feature is not to be requested in response to determining that the measure RSRP is higher than or equal to the configured threshold.

In some embodiments, the step S830 may comprise: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step S830 may comprise: determining that the second message shall be decoded as for scheduling the transmission of the third message without the feature performed.

In some embodiments, after the step S810 and before the step S830, the method 800 may further comprise: receiving, from the network node, another second message in response to the first message, wherein the step S830 may comprise: determining whether first uplink resource can be decoded from the second message for transmission of the third message with the feature performed in response to determining that the capability of the UE supports the feature; determining the first uplink resource in response to determining that the first uplink resource can be decoded from the second message; and determining second uplink resource that is decoded from the other second message for transmission of the third message without the feature performed in response to determining that no uplink resource can be decoded from the second message.

In some embodiments, the RA procedure may be a fallback from a CFRA procedure with 2-step RA type to an RA procedure with 4-step RA type. In some embodiments, before the step S830, the method 800 may further comprise: receiving the configuration indicating whether the second message shall be decoded as for scheduling the transmission of the third message with or without the feature performed. In some embodiments, the configuration may be received from another network node, wherein the configuration may be a flag in a CFRA configuration indicating whether the second message shall be decoded as for scheduling the transmission of the third message with or without the feature performed. In some embodiments, the configuration may be a flag in a DCI that orders the UE to initiate the RA procedure. In some embodiments, the configuration may be received via at least one of: dedicated RRC signaling; MAC CE; and broadcasted system information.

In some embodiments, before the step S810, the method 800 may further comprise: receiving an indicator indicating at least two sets of PRACH resources that comprise a first set indicating that the feature is requested by the UE and a second set indicating that the feature is not requested by the UE, wherein the step S810 may comprise: transmitting the first message by using a PRACH resource that is selected from the first set or the second set depending on whether the feature is to be requested or not by the UE, wherein the step S830 may comprise: determining whether the second message shall be decoded as for scheduling the transmission of the third message with or without the feature performed based on from which of the first set and the second set the PRACH resource is selected.

In some embodiments, before the step S820, the method 800 may further comprise: transmitting, to the network node, a capability indicator indicating the capability of the UE, wherein the step S830 may comprise: determining whether the second message shall be decoded as for scheduling the transmission of the third message with or without the feature performed based on the capability of the UE.

In some embodiments, the step S830 may comprise: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step S830 may comprise: determining that the second message shall be decoded as for scheduling the transmission of the third message without the feature performed. In some embodiments, after the step S810 and before the step S830, the method 800 may further comprise: receiving, from the network node, another second message in response to the first message, wherein the step S830 may comprise: determining whether first uplink resource can be decoded from the second message for transmission of the third message with the feature performed in response to determining that the capability of the UE supports the feature; determining first uplink resource that is decoded from the second message for transmission of the third message with the feature performed in response to determining that the first uplink resource can be decoded from the second message; and determining second uplink resource that is decoded from the other second message for transmission of the third message without the feature performed in response to determining that no uplink resource can be decoded from the second message.

In some embodiments, the RA procedure may be a fallback from a CBRA procedure with 2-step RA type to an RA procedure with 4-step RA type. In some embodiments, before the step S830, the method 800 may further comprise: receiving the configuration indicating whether the second message shall be decoded as for scheduling the transmission of the third message with or without the feature performed. In some embodiments, the configuration may be received via at least one of: dedicated RRC signaling; MAC CE; and broadcasted system information.

In some embodiments, before the step S810, the method 800 may further comprise: receiving an indicator indicating at least two sets of PRACH resources that comprise a first set indicating that the feature is requested by the UE and a second set indicating that the feature is not requested by the UE, wherein the step S810 may comprise: transmitting the first message by using a PRACH resource that is selected from the first set or the second set depending on whether the feature is to be requested or not by the UE, wherein the step S830 may comprise: determining whether the second message shall be decoded as for scheduling the transmission of the third message with or without the feature performed based on from which of the first set and the second set the PRACH resource is selected.

In some embodiments, the step S830 may comprise: in response to determining that there is no configuration, which is related to the feature, at the UE and that the capability of the UE supports the feature: determining first uplink resource that is decoded from the second message for transmission of the third message with the feature performed; determining second uplink resource that is decoded from the second message for transmission of the third message without the feature performed; transmitting, to the network node, the third message with the feature performed over the first uplink resource; and transmitting, to the network node, the third message without the feature performed over the second uplink resource in response to determining that the third message is not correctly decoded by the network node.

In some embodiments, the step S830 may comprise: determining that the second message shall be decoded as for scheduling the transmission of the third message without the feature performed. In some embodiments, after the step S810 and before the step S830, the method 800 may further comprise: receiving, from the network node, another second message in response to the first message, wherein the step S830 may comprise: determining whether first uplink resource can be decoded from the second message for transmission of the third message with the feature performed in response to determining that the capability of the UE supports the feature; determining first uplink resource that is decoded from the second message for transmission of the third message with the feature performed in response to determining that the first uplink resource can be decoded from the second message; and determining second uplink resource that is decoded from the other second message for transmission of the third message without the feature performed in response to determining that no uplink resource can be decoded from the second message. In some embodiments, a PRACH resource may comprise at least one of: a PRACH time/frequency resource; and a PRACH preamble sequence.

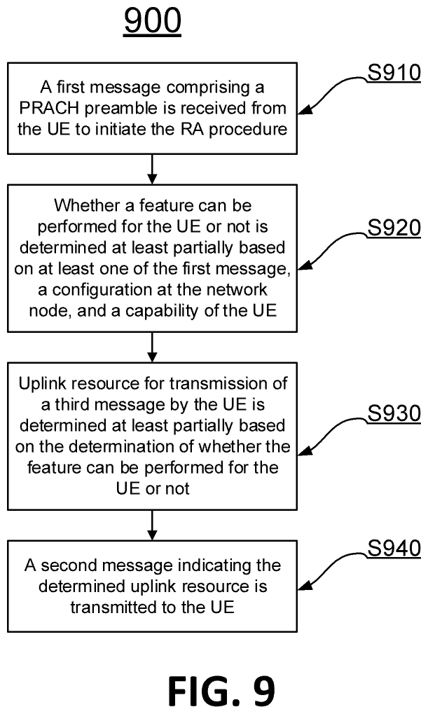

FIG. 9 is a flow chart of an exemplary method 900 at a network node for feature based random access according to an embodiment of the present disclosure. The method 900 may be performed at a network node (e.g., the gNB 120). The method 900 may comprise step S910, S920, S930, and step S940. However, the present disclosure is not limited thereto. In some other embodiments, the method 900 may comprise more steps, less steps, different steps, or any combination thereof. Further the steps of the method 900 may be performed in a different order than that described herein. Further, in some embodiments, a step in the method 900 may be split into multiple sub-steps and performed by different entities, and/or multiple steps in the method 900 may be combined into a single step.

The method 900 may begin at step S910 where a first message comprising a PRACH preamble may be received from the UE to initiate the RA procedure.

At step S920, whether a feature shall be performed for the UE or not may be determined at least partially based on at least one of the first message, a configuration at the network node, and a capability of the UE.

At step S930, uplink resource for transmission of a third message by the UE may be determined at least partially based on the determination of whether the feature shall be performed for the UE or not.

At step S940, a second message indicating the determined uplink resource may be transmitted to the UE.

In some embodiments, the method 900 may further comprise: receiving, from the UE, the third message with or without the feature performed depending on the determination of whether the feature shall be performed for the UE or not. In some embodiments, the feature may comprise at least one of: Msg3 repetition; repetition for uplink transmission scheduled by the second message; a network slice; SDT; a RedCap UE; a random access in non-terrestrial network; and a specific service type or UE priority. In some embodiments, the second message may comprise a RAR and/or a DCI.

In some embodiments, the RA procedure may be a CFRA procedure. In some embodiments, before the step S940, the method 900 may further comprise: transmitting or broadcasting the configuration indicating whether the second message shall be decoded as for scheduling the transmission of the third message with or without the feature performed. In some embodiments, the configuration may be a flag in a CFRA configuration indicating whether the second message shall be decoded as for scheduling the transmission of the third message with or without the feature performed. In some embodiments, when the RA procedure is initiated for BFR, the configuration may indicate that the second message shall always be decoded as for scheduling the transmission of the third message with the feature performed. In some embodiments, when the RA procedure is initiated for a handover, the configuration may indicate that the second message shall always be decoded as for scheduling the transmission of the third message with the feature performed.

In some embodiments, the configuration may be a preamble index, which is signaled to the UE for its PRACH transmission, indicating whether the second message shall be decoded as for scheduling the transmission of the third message with or without the feature performed. In some embodiments, the configuration may be transmitted via at least one of: dedicated RRC signaling; MAC CE; and broadcasted system information.

In some embodiments, the configuration may indicate that the second message shall always be decoded as for scheduling the transmission of the third message with the feature performed in response to determining that the capability of the UE supports the feature. In some embodiments, the configuration may be a flag in a DCI that orders the UE to initiate the RA procedure. In some embodiments, the flag may indicate whether a legacy TDRA table or another TDRA table for enabling the feature shall be used for scheduling the uplink resource for transmission of the third message. In some embodiments, before the step S920, the method 900 may further comprise: receiving, from the UE, a capability indicator indicating the capability of the UE, wherein the step S920 may comprise: determining whether the second message shall be decoded as for scheduling the transmission of the third message with or without the feature performed based on the capability of the UE.

In some embodiments, before the step S910, the method 900 may further comprise: transmitting an indicator indicating at least two sets of PRACH resources that comprise a first set indicating that the feature is requested by the UE and a second set indicating that the feature is not requested by the UE, wherein the step S910 may comprise: receiving the first message by using a PRACH resource that is selected from the first set or the second set, wherein the step S920 may comprise: determining whether the second message shall be decoded as for scheduling the transmission of the third message with or without the feature performed based on from which of the first set and the second set the PRACH resource is selected.

In some embodiments, the method 900 may further comprise one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed.

In some embodiments, the method 900 may further comprise: transmitting, to the UE, another second message indicating the second uplink resource. In some embodiments, the RA procedure may be a fallback from a CFRA procedure with 2-step RA type to an RA procedure with 4-step RA type. In some embodiments, before the step S940, the method 900 may further comprise: transmitting or broadcasting the configuration indicating whether the second message shall be decoded as for scheduling the transmission of the third message with or without the feature performed. In some embodiments, the configuration may be a flag in a CFRA configuration indicating whether the second message shall be decoded as for scheduling the transmission of the third message with or without the feature performed.

In some embodiments, the configuration may be a flag in a DCI that orders the UE to initiate the RA procedure. In some embodiments, the configuration may be transmitted via at least one of: dedicated RRC signaling; MAC CE; and broadcasted system information. In some embodiments, before the step S910, the method 900 may further comprise: transmitting an indicator indicating at least two sets of PRACH resources that comprise a first set indicating that the feature is requested by the UE and a second set indicating that the feature is not requested by the UE, wherein the step S910 may comprise: receiving the first message by using a PRACH resource that is selected from the first set or the second set, wherein the step S920 may comprise: determining whether the second message shall be decoded as for scheduling the transmission of the third message with or without the feature performed based on from which of the first set and the second set the PRACH resource is selected.

In some embodiments, before the step S920, the method 900 may further comprise: receiving, from the UE, a capability indicator indicating the capability of the UE, wherein the step S920 may comprise: determining whether the second message shall be decoded as for scheduling the transmission of the third message with or without the feature performed based on the capability of the UE.

In some embodiments, the method 900 may further comprise one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed. In some embodiments, the method 900 may further comprise: transmitting, to the UE, another second message indicating the second uplink resource.

In some embodiments, the RA procedure may be a fallback from a CBRA procedure with 2-step RA type to an RA procedure with 4-step RA type. In some embodiments, before the step S940, the method 900 may further comprise: transmitting or broadcasting the configuration indicating whether the second message shall be decoded as for scheduling the transmission of the third message with or without the feature performed. In some embodiments, the configuration may be transmitted via at least one of: dedicated RRC signaling; MAC CE; and broadcasted system information.

In some embodiments, before the step S910, the method 900 may further comprise: transmitting an indicator indicating at least two sets of PRACH resources that comprise a first set indicating that the feature is requested by the UE and a second set indicating that the feature is not requested by the UE, wherein the step S910 may comprise: receiving the first message by using a PRACH resource that is selected from the first set or the second set, wherein the step S920 may comprise: determining whether the second message shall be decoded as for scheduling the transmission of the third message with or without the feature performed based on from which of the first set and the second set the PRACH resource is selected.

In some embodiments, the method 900 may further comprise one of: determining a second uplink resource for transmission of the third message by the UE with the feature performed in response to the uplink resource being determined for transmission of the third message by the UE without the feature performed; and determining a second uplink resource for transmission of the third message by the UE without the feature performed in response to the uplink resource being determined for transmission of the third message by the UE with the feature performed.

In some embodiments, the method 900 may further comprise: transmitting, to the UE, another second message indicating the second uplink resource. In some embodiments, a PRACH resource may comprise at least one of: a PRACH time/frequency resource; and a PRACH preamble sequence.

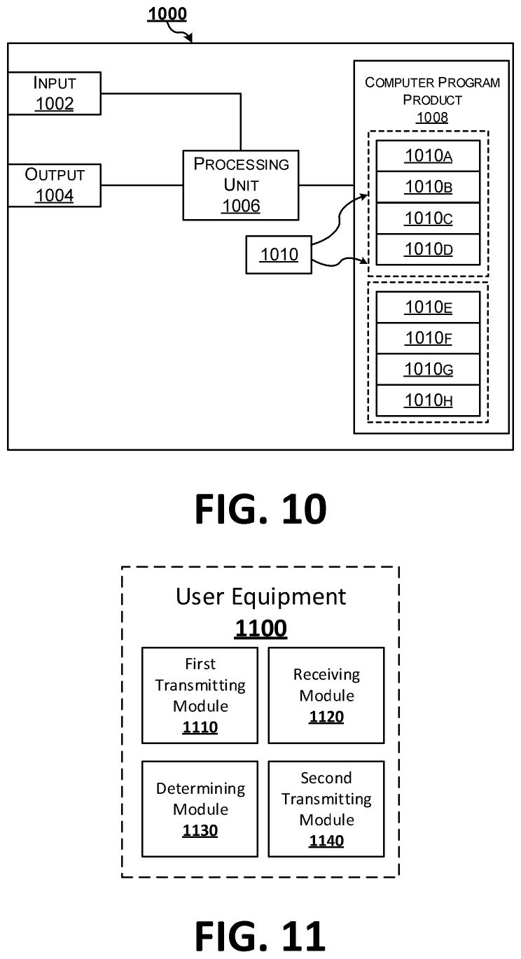

FIG. 10 schematically shows an embodiment of an arrangement 1000 which may be used in a user equipment (e.g., the UE 110) or a network node (e.g., the gNB 120) according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the UE/network node in which it is comprised to perform the actions, e.g., of the procedure described earlier in conjunction with FIG. 7 to FIG. 9 or any other variant.

The computer program 1010 may be configured as a computer program code structured in computer program modules 1010A, 1010B, 1010C, and 1010D. Hence, in an exemplifying embodiment when the arrangement 1000 is used in a UE, the code in the computer program of the arrangement 1000 includes: a module 1010A for transmitting, to the network node, a first message comprising a PRACH preamble to initiate the RA procedure; a module 1010B for receiving, from the network node, a second message in response to the first message; a module 1010C for determining whether a feature is to be performed or not at least partially based on at least one of the second message, a configuration at the UE, and a capability of the UE; and a module 1010D for transmitting, to the network node, a third message with or without the feature performed depending on a result of the determination.

Further, the computer program 1010 may be further configured as a computer program code structured in computer program modules 1010E, 1010F, 1010G, and 1010H. Hence, in an exemplifying embodiment when the arrangement 1000 is used in a network node, the code in the computer program of the arrangement 1000 includes: a module 1010E for receiving, from the UE, a first message comprising a PRACH preamble to initiate the RA procedure; a module 1010F for determining whether a feature shall be performed for the UE or not at least partially based on at least one of the first message, a configuration at the network node, and a capability of the UE; a module 1010G for determining uplink resource for transmission of a third message by the UE at least partially based on the determination of whether the feature shall be performed for the UE or not; and a module 1010H for transmitting, to the UE, a second message indicating the determined uplink resource.

The computer program modules could essentially perform the actions of the flow illustrated in FIG. 7 to FIG. 9, to emulate the UE or the network node. In other words, when the different computer program modules are executed in the processing unit 1006, they may correspond to different modules in the UE or the network node.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE and/or the network node.

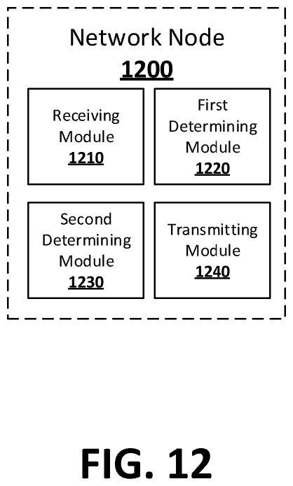

Correspondingly to the method 800 as described above, an exemplary user equipment is provided. FIG. 11 is a block diagram of a UE 1100 according to an embodiment of the present disclosure. The UE 1100 may be, e.g., the UE 110 in some embodiments.

The UE 1100 may be configured to perform the method 800 as described above in connection with FIG. 8. As shown in FIG. 11, the UE 1100 may comprise a first transmitting module 1110 for transmitting, to the network node, a first message comprising a PRACH preamble to initiate the RA procedure; a receiving module 1120 for receiving, from the network node, a second message in response to the first message; a determining module 1130 for determining whether a feature is to be performed or not at least partially based on at least one of the second message, a configuration at the UE, and a capability of the UE; and a second transmitting module 1140 for transmitting, to the network node, a third message with or without the feature performed depending on a result of the determination.

The above modules 1110, 1120, 1130, and/or 1140 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the UE 1100 may comprise one or more further modules, each of which may perform any of the steps of the method 800 described with reference to FIG. 8.

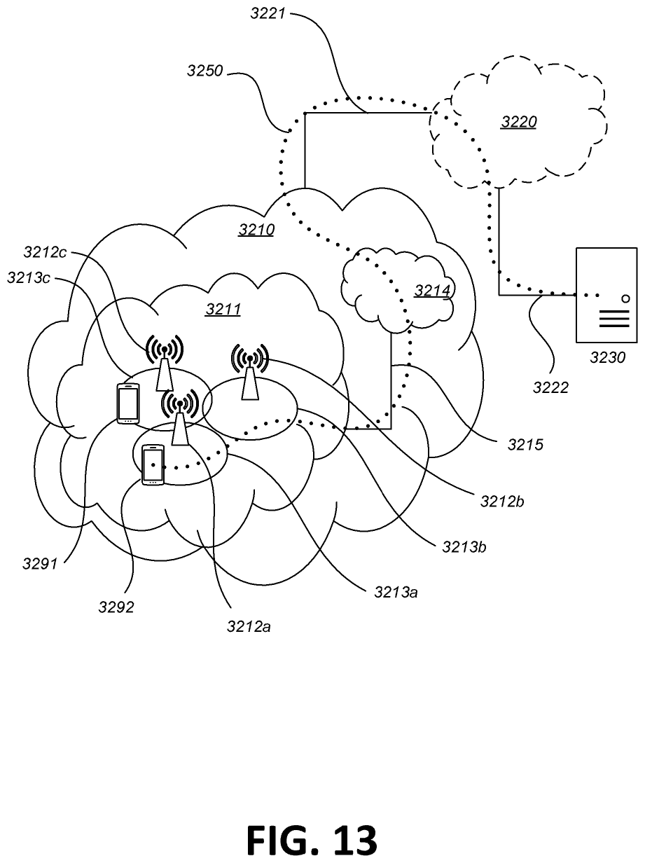

Correspondingly to the method 900 as described above, a network node is provided. FIG. 12 is a block diagram of an exemplary network node 1200 according to an embodiment of the present disclosure. The network node 1200 may be, e.g., the gNB 120 in some embodiments.

The network node 1200 may be configured to perform the method 900 as described above in connection with FIG. 9. As shown in FIG. 12, the network node 1200 may comprise a receiving module 1210 for receiving, from the UE, a first message comprising a PRACH preamble to initiate the RA procedure; a first determining module 1220 for determining whether a feature shall be performed for the UE or not at least partially based on at least one of the first message, a configuration at the network node, and a capability of the UE; a second determining module 1230 for determining uplink resource for transmission of a third message by the UE at least partially based on the determination of whether the feature shall be performed for the UE or not; and a transmitting module 1240 for transmitting, to the UE, a second message indicating the determined uplink resource.

The above modules 1210, 1220, 1230, and/or 1240 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 9. Further, the network node 1200 may comprise one or more further modules, each of which may perform any of the steps of the method 900 described with reference to FIG. 9.

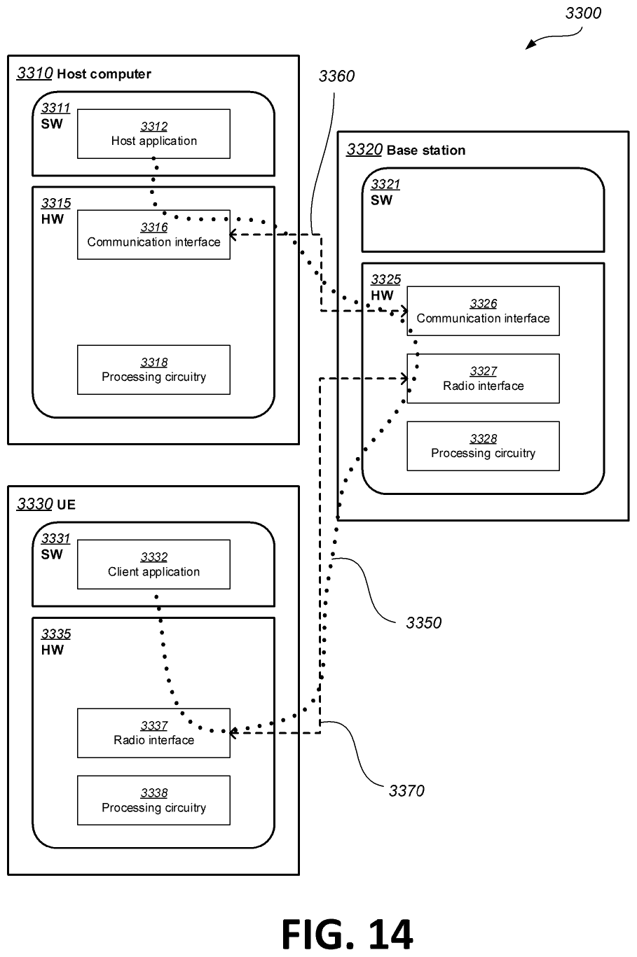

With reference to FIG. 13, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

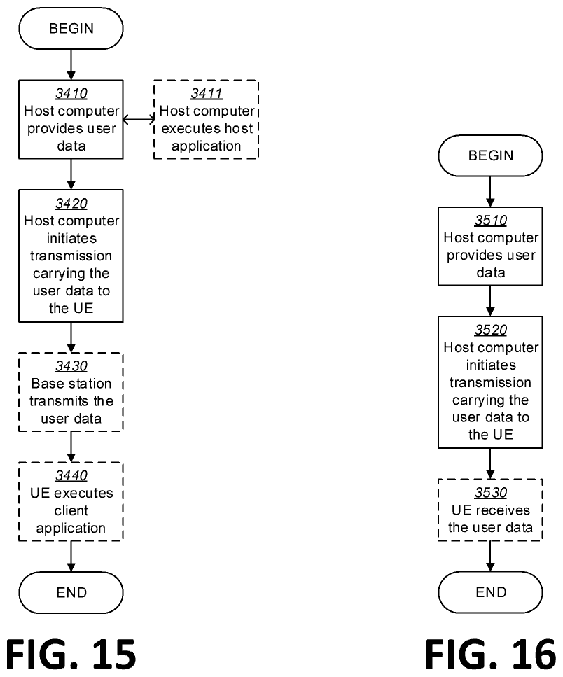

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure One or more of the various embodiments improve the performance of OTT services provided to the UE 3330 using the OTT connection 3350, in which the wireless connection 3370 forms the last segment. More precisely, the teachings of these embodiments may improve the latency and power consumption and thereby provide benefits such as reduced user waiting time, better responsiveness, extended battery lifetime.

A measurement procedure may be provided for the purpose of monitoring data rate, latency, and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency, and the like. The measurements may be implemented in that the software 3311, 3331 causes messages to be transmitted, in particular empty or ‘dummy’ messages, using the OTT connection 3350 while it monitors propagation times, errors etc.

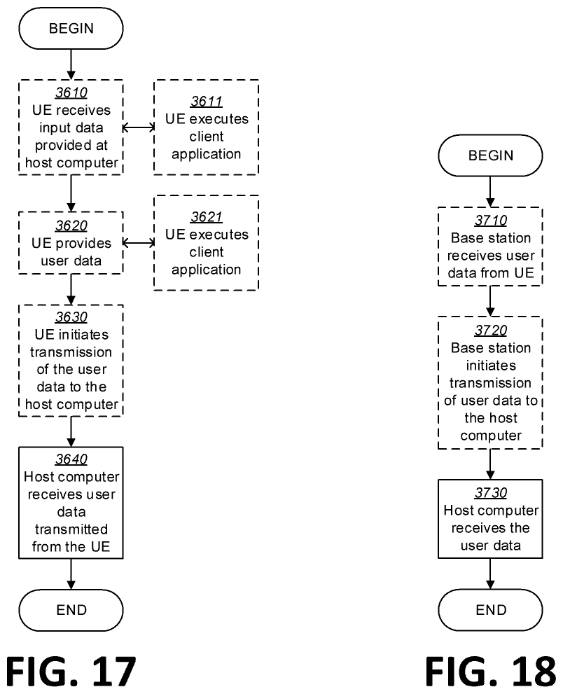

FIG. 15 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

FIG. 17 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 17 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 18 is a flowchart illustrating a method implemented in a communication system, in accordance with one embodiment. The communication system includes a host computer, a base station and a UE which may be those described with reference to FIG. 13 and FIG. 14. For simplicity of the present disclosure, only drawing references to FIG. 18 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

| Abbreviation | Explanation |
|---|---|
| CBRA | Contention Based Random Access |
| CFRA | Contention Free Random Access |
| CP | Cyclic Prefix |
| DCI | Downlink Control Information |
| PDCCH | Physical Downlink Control Channel |
| PRACH | Physical Random Access Channel |
| PUSCH | Physical Uplink Shared Channel |
| RACH | Random Access Channel |
| RAR | Random Access Response |
| RO | PRACH occasion, i.e., the timing frequency |
| | resource used for one PRACH transmission |
| RSRP | Reference Signal Received Power |
| SSB | Synchronization Signal Block |
| TB | Transport Block |
| TBS | Transport Block Size |

1. A method at a user equipment (UE) for performing a random access (RA) procedure with a network node, the method comprising:
transmitting, to the network node, a first message comprising a physical random access channel (PRACH) preamble to initiate the RA procedure;
receiving, from the network node, a second message in response to the first message;
determining whether a feature is to be performed or not at least partially based on at least one of the second message, a configuration at the UE, and a capability of the UE; and
transmitting, to the network node, a third message with or without the feature performed depending on a result of the determination.

2. The method of claim 1, wherein the feature comprises at least one of:
Msg3 repetition;
repetition for uplink transmission scheduled by the second message;
a network slice;
small data transmission (SDT);
a UE with reduced capability (RedCap UE);
a random access in non-terrestrial network; and
a specific service type or UE priority.

3. The method of claim 1, wherein the second message comprises a random access response (RAR) and/or a downlink control information (DCI),
wherein the step of determining whether a feature is to be performed or not comprises:
determining whether the feature is to be performed or not at least partially based on at least one of the configuration at the UE, the capability of the UE, the RAR, and the DCI.

4-30. (canceled)

31. The method of claim 1, wherein the RA procedure is a fallback from a CBRA procedure with 2-step RA type to an RA procedure with 4-step RA type.

32. The method of claim 31, wherein before the step of determining whether a feature is to be performed or not, the method further comprises:
receiving the configuration indicating whether the second message shall be decoded as for scheduling the transmission of the third message with or without the feature performed.

33. The method of claim 32, wherein the configuration is received via at least one of:
dedicated radio resource control (RRC) signaling;
medium access control (MAC) control element (CE); and
broadcasted system information.

34. The method of claim 31, wherein before the step of transmitting, to the network node, a first message, the method further comprises: receiving an indicator indicating at least two sets of PRACH resources that comprise a first set indicating that the feature is requested by the UE and a second set indicating that the feature is not requested by the UE,
wherein the step of transmitting, to the network node, a first message comprises: transmitting the first message by using a PRACH resource that is selected from the first set or the second set depending on whether the feature is to be requested or not by the UE,
wherein the step of determining whether a feature is to be performed or not comprises: determining whether the second message shall be decoded as for scheduling the transmission of the third message with or without the feature performed based on from which of the first set and the second set the PRACH resource is selected.

35. The method of claim 31, wherein the step of determining whether a feature is to be performed or not comprises:
in response to determining that there is no configuration, which is related to the feature, at the UE and that the capability of the UE supports the feature:
determining first uplink resource that is decoded from the second message for transmission of the third message with the feature performed;
determining second uplink resource that is decoded from the second message for transmission of the third message without the feature performed;
transmitting, to the network node, the third message with the feature performed over the first uplink resource; and
transmitting, to the network node, the third message without the feature performed over the second uplink resource in response to determining that the third message is not correctly decoded by the network node.

36. The method of claim 31, wherein the step of determining whether a feature is to be performed or not comprises:
determining that the second message shall be decoded as for scheduling the transmission of the third message without the feature performed.

37. The method of claim 31, wherein after the step of transmitting, to the network node, a first message and before the step of determining whether a feature is to be performed or not, the method further comprises: receiving, from the network node, another second message in response to the first message,
wherein the step of determining whether a feature is to be performed or not comprises:
determining whether first uplink resource can be decoded from the second message for transmission of the third message with the feature performed in response to determining that the capability of the UE supports the feature;
determining first uplink resource that is decoded from the second message for transmission of the third message with the feature performed in response to determining that the first uplink resource can be decoded from the second message; and
determining second uplink resource that is decoded from the other second message for transmission of the third message without the feature performed in response to determining that no uplink resource can be decoded from the second message.

38. The method of claim 1, wherein a PRACH resource comprises at least one of:
a PRACH time/frequency resource; and
a PRACH preamble sequence.

39. A user equipment, comprising:
a processor;
a memory storing instructions which, when executed by the processor, cause the processor to perform of:
transmitting, to the network node, a first message comprising a physical random access channel (PRACH) preamble to initiate the RA procedure;
receiving, from the network node, a second message in response to the first message;
determining whether a feature is to be performed or not at least partially based on at least one of the second message, a configuration at the UE, and a capability of the UE; and
transmitting, to the network node, a third message with or without the feature performed depending on a result of the determination.

40. A method at a network node for performing a random access (RA) procedure with a user equipment (UE), the method comprising:
receiving, from the UE, a first message comprising a physical random access channel (PRACH) preamble to initiate the RA procedure;
determining whether a feature shall be performed for the UE or not at least partially based on at least one of the first message, a configuration at the network node, and a capability of the UE;
determining uplink resource for transmission of a third message by the UE at least partially based on the determination of whether the feature shall be performed for the UE or not; and
transmitting, to the UE, a second message indicating the determined uplink resource.

41. The method of claim 40, further comprising:
receiving, from the UE, the third message with or without the feature performed depending on the determination of whether the feature shall be performed for the UE or not.

42. The method of claim 40, wherein the feature comprises at least one of:
Msg3 repetition;
repetition for uplink transmission scheduled by the second message;
a network slice;
small data transmission (SDT);
a UE with reduced capability (RedCap UE);
a random access in non-terrestrial network; and
a specific service type or UE priority.

43-66. (canceled)

67. The method of claim 40, wherein the RA procedure is a fallback from a CBRA procedure with 2-step RA type to an RA procedure with 4-step RA type.

68. The method of claim 67, wherein before the step of transmitting, to the UE, a second message, the method further comprises:
transmitting or broadcasting the configuration indicating whether the second message shall be decoded as for scheduling the transmission of the third message with or without the feature performed.

69. The method of claim 68, wherein the configuration is transmitted via at least one of:
dedicated radio resource control (RRC) signaling;
medium access control (MAC) control element (CE); and
broadcasted system information.

70. The method of claim 67, wherein before the step of receiving, from the UE, a first message, the method further comprises:
transmitting an indicator indicating at least two sets of PRACH resources that comprise a first set indicating that the feature is requested by the UE and a second set indicating that the feature is not requested by the UE,
wherein the step of receiving, from the UE, a first message comprises: receiving the first message by using a PRACH resource that is selected from the first set or the second set,
wherein the step of determining whether a feature shall be performed for the UE or not comprises: determining whether the second message shall be decoded as for scheduling the transmission of the third message with or without the feature performed based on from which of the first set and the second set the PRACH resource is selected.

71. The method of claim 67, further comprising one of:
determining a second uplink resource for transmission of the third message by the UE with the feature performed in response to the uplink resource being determined for transmission of the third message by the UE without the feature performed; and
determining a second uplink resource for transmission of the third message by the UE without the feature performed in response to the uplink resource being determined for transmission of the third message by the UE with the feature performed.

72-77. (canceled)
